(19) United States
(12) Patent Application Publication
(10) Pub. No.: US 2026/0280668 A1
(43) Pub. Date: Sep. 17, 2026

(54) TECHNIQUES FOR SIGNALING PARAMETER IDENTIFIERS FOR DATA COLLECTION IN BEAM PREDICTION

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US)

(21) Appl. No.: 19/168,761

(22) PCT Filed: May 12, 2023
(86) PCT No.: PCT/CN2023/093784

§ 371 Date: Sep. 24, 2025

(51) Int. Cl. H04B 7/06; H04L 41/16

(52) U.S. Cl. CPC H04B 7/06952; H04L 41/16

(57) ABSTRACT

Methods, systems, and devices for wireless communications are described. The described techniques provide for signaling between the network and a user equipment (UE) indicating current or changing parameters used by the network entity to transmit synchronization signal blocks (SSBs) or channel state information reference signals (CSI-RSs). The network entity may transmit, to the UE, an indication of parameter identifiers, indicating the parameters used by the network entity to transmit SSBs and/or CSI-RSs via one or more beams. The network may configure the beams (e.g., for SSB or CSI-RS transmission), and may indicate the parameter identifiers used for SSB transmission or CSI-RS transmission in a same message as the configured beams (e.g., in the same radio resource control (RRC) message) or in a different message (e.g., via another radio resource control message, a media access control (MAC) control element (CE) MAC-CE message, or downlink control information (DCI) message).

### CROSS REFERENCE

This application is a 371 National Stage of PCT Application No. PCT/CN2023/093784, filed on May 12, 2023, entitled “TECHNIQUES FOR SIGNALING PARAMETER IDENTIFIERS FOR DATA COLLECTION IN BEAM PREDICTION”, and assigned to the assignee hereof. The disclosure of the prior Application is considered part of and is incorporated by reference into this Patent Application.

### FIELD OF DISCLOSURE

The following relates to wireless communications, including techniques for signaling parameter identifiers for data collection in beam prediction.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for signaling parameter identifiers for data collection in beam prediction. For example, the described techniques provide for signaling between the network and a user equipment (UE) indicating current or changing parameters used by the network entity to transmit synchronization signal blocks (SSBs) or channel state information reference signals (CSI-RSs). For example, the network entity may transmit, to the UE, an indication of parameter identifiers, indicating the parameters used by the network entity to transmit SSBs and/or CSI-RSs via one or more beams. The network may configure the beams (e.g., for SSB or CSI-RS transmission), and may indicate the parameter identifiers (IDs) used for SSB transmission or CSI-RS transmission in a same message as the configured beams (e.g., in the same radio resource control (RRC) message) or in a different message (e.g., via another RRC message, a media access control (MAC) control element (CE) message, or downlink control information (DCI) message).

The UE may request the indication of parameter identifiers (e.g., may indicate that it will begin data collection for the beam prediction ML model), and may receive the parameter identifiers based thereon. The parameters may include a Spatial transmit filter codebook identifier associated with the UE measured SSBs or CSI-RSs, an antenna panel identifier associated with the UE measured SSBs or CSI-RSs, an indication of whether the measured SSBs or CSI-RSs are involved with a reconfigurable intelligent surface (RIS), an interference level identifier associated with the UE measured SSBs or CSI-RSs, based on measurements or predictions by the network entity, a transmit power level identifier associated with the UE measured SSBs or CSI-RSs, or an identifier of an environment, scenarios, or surrounding conditions associated with the UE.

A method for wireless communications at a user equipment (UE) is described. The method may include receiving first control signaling indicating a set of multiple beams for a set of measurements, the set of measurements including reference signal receive power, a signal to interference and noise ratio, a channel impulsive response, or any combination thereof, receiving second control signaling including an indication of a first set of parameter identifiers of a set of multiple parameter identifiers, the first set of parameter identifiers associated with the set of measurements, performing the set of measurements via the set of multiple beams based on the first set of parameter identifiers, and aggregating the set of measurements based on the first set of parameter identifiers.

An apparatus for wireless communications at a UE is described. The apparatus may include a processor, memory coupled with the processor, and instructions stored in the memory. The instructions may be executable by the processor to cause the apparatus to receive first control signaling indicating a set of multiple beams for a set of measurements, the set of measurements including reference signal receive power, a signal to interference and noise ratio, a channel impulsive response, or any combination thereof, receive second control signaling including an indication of a first set of parameter identifiers of a set of multiple parameter identifiers, the first set of parameter identifiers associated with the set of measurements, perform the set of measurements via the set of multiple beams based on the first set of parameter identifiers, and aggregate the set of measurements based on the first set of parameter identifiers.

Another apparatus for wireless communications at a UE is described. The apparatus may include means for receiving first control signaling indicating a set of multiple beams for a set of measurements, the set of measurements including reference signal receive power, a signal to interference and noise ratio, a channel impulsive response, or any combination thereof, means for receiving second control signaling including an indication of a first set of parameter identifiers of a set of multiple parameter identifiers, the first set of parameter identifiers associated with the set of measurements, means for performing the set of measurements via the set of multiple beams based on the first set of parameter identifiers, and means for aggregating the set of measurements based on the first set of parameter identifiers.

A non-transitory computer-readable medium storing code for wireless communications at a UE is described. The code may include instructions executable by a processor to receive first control signaling indicating a set of multiple beams for a set of measurements, the set of measurements including reference signal receive power, a signal to interference and noise ratio, a channel impulsive response, or any combination thereof, receive second control signaling including an indication of a first set of parameter identifiers of a set of multiple parameter identifiers, the first set of parameter identifiers associated with the set of measurements, perform the set of measurements via the set of multiple beams based on the first set of parameter identifiers, and aggregate the set of measurements based on the first set of parameter identifiers.

Some examples of the method, apparatuses, and non-transitory computer-readable medium described herein may further include operations, features, means, or instructions for communicating with a network entity via one or more beams of the set of multiple beams selected in accordance with a first machine learning (ML) model according to the set of measurements.

Some examples of the method, apparatuses, and non-transitory computer-readable medium described herein may further include operations, features, means, or instructions for transmitting a request message indicating that the UE supports data collection for one or more ML models including a first ML model corresponding to beam prediction based on the set of measurements, where receiving the second control signaling including the indication of the first set of parameter identifiers may be based on transmitting the request message.

Some examples of the method, apparatuses, and non-transitory computer-readable medium described herein may further include operations, features, means, or instructions for receiving third control signaling including an indication of a second set of parameter identifiers of the set of multiple parameter identifiers, the second set of parameter identifiers associated with a second ML model corresponding to beam prediction based on the set of measurements.

Some examples of the method, apparatuses, and non-transitory computer-readable medium described herein may further include operations, features, means, or instructions for performing a second set of measurements via a second set of multiple beams based on the second set of parameter identifiers and communicating with a network entity via one or more beams of the second set of multiple beams selected in accordance with the second ML model according to the second the set of measurements.

In some examples of the method, apparatuses, and non-transitory computer-readable medium described herein, the first set of parameter identifiers include a spatial transmission filter codebook identifier associated with the set of multiple beams, an antenna panel identifier associated with one or more beams, an identifier associated with a reconfigurable intelligent surface, a predicted interference level identifier, a transmit power level identifier, a scenario identifier, or any combination thereof.

In some examples of the method, apparatuses, and non-transitory computer-readable medium described herein, each parameter identifier of the first set of parameter identifiers corresponds to the set of multiple beams.

In some examples of the method, apparatuses, and non-transitory computer-readable medium described herein, each parameter identifier of the first set of parameter identifiers applies to a respective beam of the set of multiple beams.

Some examples of the method, apparatuses, and non-transitory computer-readable medium described herein may further include operations, features, means, or instructions for receiving a RRC message including the first control signaling and the second control signaling, the RRC message indicating resources corresponding to the set of multiple beams.

Some examples of the method, apparatuses, and non-transitory computer-readable medium described herein may further include operations, features, means, or instructions for receiving a MAC-CE activating one or more resources for the set of measurements, the MAC-CE including the second control signaling.

Some examples of the method, apparatuses, and non-transitory computer-readable medium described herein may further include operations, features, means, or instructions for receiving the second control signaling via a DCI message.

Some examples of the method, apparatuses, and non-transitory computer-readable medium described herein may further include operations, features, means, or instructions for receiving third control signaling including an indication of a threshold time period, transmitting an acknowledgement message corresponding to the second control signaling, and applying the first set of parameter identifiers to a first ML model corresponding to beam prediction based on the set of measurements upon expiration of the threshold time period after transmitting the acknowledgement message.

Some examples of the method, apparatuses, and non-transitory computer-readable medium described herein may further include operations, features, means, or instructions for receiving, via the first control signaling, an indication of a set of resources corresponding to the set of measurements and applying the first set of parameter identifiers to a first ML model corresponding to beam prediction for the set of measurements via the set of resources based on the first control signaling.

Some examples of the method, apparatuses, and non-transitory computer-readable medium described herein may further include operations, features, means, or instructions for training a first ML model corresponding to beam prediction based on the set of measurements based on aggregating the measurements, where communicating with a network entity via one or more beams selected in accordance with the first ML model may be based on the training.

In some examples of the method, apparatuses, and non-transitory computer-readable medium described herein, the set of multiple beams correspond to a set of multiple synchronization signal blocks, a set of multiple channel state information reference signals, or a combination thereof.

Some examples of the method, apparatuses, and non-transitory computer-readable medium described herein may further include operations, features, means, or instructions for receiving control signaling indicating a beam prediction mode, where receiving the second control signaling may be based on receiving the control signaling indicating the beam prediction mode.

Some examples of the method, apparatuses, and non-transitory computer-readable medium described herein may further include operations, features, means, or instructions for selecting a first ML model corresponding to beam prediction based on the set of measurements based on the first set of parameter identifiers and performing beam prediction according to the set of measurements and the selected first ML model.

In some examples of the method, apparatuses, and non-transitory computer-readable medium described herein, the indication of the first set of parameter identifiers of the set of multiple parameter identifiers includes a set of similarly values, each similarity value indicating a percentage of similarly between a parameter identifier of the first set of parameter identifiers and a respective reference parameter value.

A method for wireless communications at a network entity is described. The method may include transmitting first control signaling indicating a set of multiple beams for a set of measurements by a UE, the set of measurements including reference signal receive power, a signal to interference and noise ratio, a channel impulsive response, or any combination thereof, transmitting second control signaling including an indication of a first set of parameter identifiers of a set of multiple parameter identifiers, the first set of parameter identifiers associated with the set of measurements, and communicating with the UE via one or more beams of the set of multiple beams based on the first set of parameter identifiers, and the set of measurements.

An apparatus for wireless communications at a network entity is described. The apparatus may include a processor, memory coupled with the processor, and instructions stored in the memory. The instructions may be executable by the processor to cause the apparatus to transmit first control signaling indicating a set of multiple beams for a set of measurements by a UE, the set of measurements including reference signal receive power, a signal to interference and noise ratio, a channel impulsive response, or any combination thereof, transmit second control signaling including an indication of a first set of parameter identifiers of a set of multiple parameter identifiers, the first set of parameter identifiers associated with the set of measurements, and communicate with the UE via one or more beams of the set of multiple beams based on the first set of parameter identifiers, and the set of measurements.

Another apparatus for wireless communications at a network entity is described. The apparatus may include means for transmitting first control signaling indicating a set of multiple beams for a set of measurements by a UE, the set of measurements including reference signal receive power, a signal to interference and noise ratio, a channel impulsive response, or any combination thereof, means for transmitting second control signaling including an indication of a first set of parameter identifiers of a set of multiple parameter identifiers, the first set of parameter identifiers associated with the set of measurements, and means for communicating with the UE via one or more beams of the set of multiple beams based on the first set of parameter identifiers, and the set of measurements.

A non-transitory computer-readable medium storing code for wireless communications at a network entity is described. The code may include instructions executable by a processor to transmit first control signaling indicating a set of multiple beams for a set of measurements by a UE, the set of measurements including reference signal receive power, a signal to interference and noise ratio, a channel impulsive response, or any combination thereof, transmit second control signaling including an indication of a first set of parameter identifiers of a set of multiple parameter identifiers, the first set of parameter identifiers associated with the set of measurements, and communicate with the UE via one or more beams of the set of multiple beams based on the first set of parameter identifiers, and the set of measurements.

Some examples of the method, apparatuses, and non-transitory computer-readable medium described herein may further include operations, features, means, or instructions for receiving a request message indicating that the UE supports data collection for one or more ML models including a first ML model corresponding to beam prediction based on the set of measurements, where transmitting the second control signaling including the indication of the first set of parameter identifiers may be based on receiving the request message.

Some examples of the method, apparatuses, and non-transitory computer-readable medium described herein may further include operations, features, means, or instructions for transmitting third control signaling including an indication of a second set of parameter identifiers of the set of multiple parameter identifiers, the second set of parameter identifiers associated with a second ML model corresponding to beam prediction based on the set of measurements and performing additional communications with the UE via one or more beams of a second set of multiple beams in accordance with the second ML model, the second set of parameter identifiers, and the set of measurements.

Some examples of the method, apparatuses, and non-transitory computer-readable medium described herein may further include operations, features, means, or instructions for transmitting, via the set of multiple beams, a first set of reference signals based on the first set of parameter identifiers using a first transmission filter, where the communicating with the UE may be based on the first set of reference signals and transmitting, via a second set of multiple beams, a second set of reference signals based on the second set of parameter identifiers using a second transmission filter, where performing the additional communications with the UE may be based on the second set of reference signals.

In some examples of the method, apparatuses, and non-transitory computer-readable medium described herein, the first transmission filter at least partially overlaps with the second transmission filter.

In some examples of the method, apparatuses, and non-transitory computer-readable medium described herein, the first set of parameter identifiers include a spatial transmission filter codebook identifier associated with the set of multiple beams, an antenna panel identifier associated with one or more beams, an identifier associated with a reconfigurable intelligent surface, a predicted interference level identifier, a transmit power level identifier, a scenario identifier, or any combination thereof.

In some examples of the method, apparatuses, and non-transitory computer-readable medium described herein, each parameter identifier of the first set of parameter identifiers corresponds to the set of multiple beams.

In some examples of the method, apparatuses, and non-transitory computer-readable medium described herein, each parameter identifier of the first set of parameter identifiers applies to a respective beam of the set of multiple beams.

Some examples of the method, apparatuses, and non-transitory computer-readable medium described herein may further include operations, features, means, or instructions for transmitting third control signaling including an indication of a threshold time period, where the communicating with the UE occurs at least the threshold time period after receiving an acknowledgement message corresponding to the second control signaling.

In some examples of the method, apparatuses, and non-transitory computer-readable medium described herein, the set of multiple beams correspond to a set of multiple synchronization signal blocks, a set of multiple channel state information reference signals, or a combination thereof.

(This summary will be completed upon final approval of the claims)

### BRIEF DESCRIPTION OF THE DRAWINGS

FIG. 1 shows an example of a wireless communications system that supports techniques for signaling parameter identifiers for data collection in beam prediction in accordance with one or more aspects of the present disclosure.

FIG. 2 shows an example of a wireless communications system that supports techniques for signaling parameter identifiers for data collection in beam prediction in accordance with one or more aspects of the present disclosure.

FIG. 3 shows an example of a timeline that supports techniques for signaling parameter identifiers for data collection in beam prediction in accordance with one or more aspects of the present disclosure.

FIG. 4 shows an example of a process flow that supports techniques for signaling parameter identifiers for data collection in beam prediction in accordance with one or more aspects of the present disclosure.

FIGS. 5 and 6 show block diagrams of devices that support techniques for signaling parameter identifiers for data collection in beam prediction in accordance with one or more aspects of the present disclosure.

FIG. 7 shows a block diagram of a communications manager that supports techniques for signaling parameter identifiers for data collection in beam prediction in accordance with one or more aspects of the present disclosure.

FIG. 8 shows a diagram of a system including a device that supports techniques for signaling parameter identifiers for data collection in beam prediction in accordance with one or more aspects of the present disclosure.

FIGS. 9 and 10 show block diagrams of devices that support techniques for signaling parameter identifiers for data collection in beam prediction in accordance with one or more aspects of the present disclosure.

FIG. 11 shows a block diagram of a communications manager that supports techniques for signaling parameter identifiers for data collection in beam prediction in accordance with one or more aspects of the present disclosure.

FIG. 12 shows a diagram of a system including a device that supports techniques for signaling parameter identifiers for data collection in beam prediction in accordance with one or more aspects of the present disclosure.

FIGS. 13 through 16 show flowcharts illustrating methods that support techniques for signaling parameter identifiers for data collection in beam prediction in accordance with one or more aspects of the present disclosure.

### DETAILED DESCRIPTION

A user equipment (UE) in a wireless communications system may support machine learning (ML)-based procedures, such as beam prediction. Such a UE may collect data measurements (e.g., reference signal receive power (RSRP), signal to interference and noise ratio (SINR), channel impulsive response (CIR), among other examples) based on measurements of synchronization system blocks (SSBs) or channel state information reference signals (CSI-RSs) via SSB beams or CSI-RS beams.

However, the network entity my change one or more parameters while transmitting SSBs or CSI-RSs. For instance, the network entity may change parameters including transmit power, antenna panel, spatial transmit filter, or the like. Some parameter changes may be transparent to the UE, while other parameter changes may not be transparent to the UE. In either case, the UE may misinterpret or not have access to information regarding such changes at the network side, which may impact the effectiveness of the ML model. The ML model may more effectively predict beams based on one or more inputs (e.g., according to current conditions) if such parameters are identified by the UE and provided to the ML model. The lack of such information may result in degraded beam prediction performance, decreased reliability of wireless communications, increased system latency, and decreased user experience.

Techniques described herein support signaling between the network and the UE indicating current or changing parameters used by the network entity to transmit SSBs or CSI-RSs. For example, the network entity may transmit, to the UE, an indication of parameter identifiers, indicating the parameters used by the network entity to transmit SSBs and/or CSI-RSs via one or more beams. The network may configure the beams (e.g., for SSB or CSI-RS transmission), and may indicate the parameter identifiers (IDs) used for SSB transmission or CSI-RS transmission in a same message as the configured beams (e.g., in the same RRC message) or in a different message (e.g., via another RRC message, a MAC-CE message, or downlink control information (DCI) message). The UE may request the indication of parameter identifiers (e.g., may indicate that it will begin data collection for the beam prediction ML model), and may receive the parameter identifiers based thereon. The parameters may include a Spatial transmit filter codebook identifier associated with the UE measured SSBs or CSI-RSs, an antenna panel identifier associated with the UE measured SSBs or CSI-RSs, an indication of whether the measured SSBs or CSI-RSs are involved with a reconfigurable intelligent surface (RIS), an interference level identifier associated with the UE measured SSBs or CSI-RSs, based on measurements or predictions by the network entity, a transmit power level identifier associated with the UE measured SSBs or CSI-RSs, or an identifier of an environment, scenarios, or surrounding conditions associated with the UE.

Aspects of the disclosure are initially described in the context of wireless communications systems. Aspects of the disclosure are further illustrated by and described with reference to wireless communications systems, timelines, and process flows. Aspects of the disclosure are further illustrated by and described with reference to apparatus diagrams, system diagrams, and flowcharts that relate to techniques for signaling parameter identifiers for data collection in beam prediction.

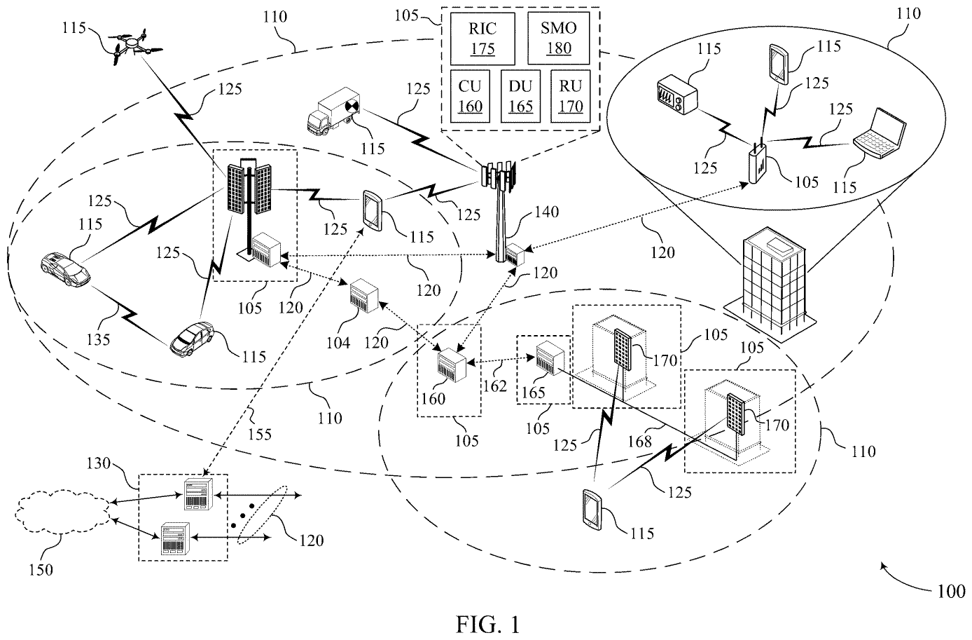

FIG. 1 shows an example of a wireless communications system 100 that supports techniques for signaling parameter identifiers for data collection in beam prediction in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol).

Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN.

Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104.

Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for signaling parameter identifiers for data collection in beam prediction as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas.

Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the UE 115 may support UE-side artificial intelligence (AI) or ML models (as described herein, an ML model may refer to an AI model or an AI/ML model). Such an ML model may support one or more applications or procedures for the UE 115. For example, the UE 115 may support a beam prediction ML model, which may be based on one or mor downlink reference signal transmissions and measurements of such transmissions. In some examples, the UE 115 may perform data collection for UE-side ML models. Techniques described herein may support initiation or triggering o data collection based on configuration from the network, or based on UE request for data collection.

For example, the network entity may transmit, to the UE 115, an indication of parameter identifiers, indicating the parameters used by the network entity to transmit SSBs and/or CSI-RSs via one or more beams. The network may configure the beams (e.g., for SSB or CSI-RS transmission), and may indicate the parameter identifiers used for SSB transmission or CSI-RS transmission in a same message as the configured beams (e.g., in the same RRC message) or in a different message (e.g., via another RRC message, a MAC-CE message, or DCI message). The UE 115 may request the indication of parameter identifiers (e.g., may indicate that it will begin data collection for the beam prediction ML model), and may receive the parameter identifiers based thereon. The parameters may include a Spatial transmit filter codebook identifier associated with the UE measured SSBs or CSI-RSs, an antenna panel identifier associated with the UE measured SSBs or CSI-RSs, an indication of whether the measured SSBs or CSI-RSs are involved with a RIS, an interference level identifier associated with the UE 115 measured SSBs or CSI-RSs, based on measurements or predictions by the network entity, a transmit power level identifier associated with the UE 115 measured SSBs or CSI-RSs, or an identifier of an environment, scenarios, or surrounding conditions associated with the UE 115.

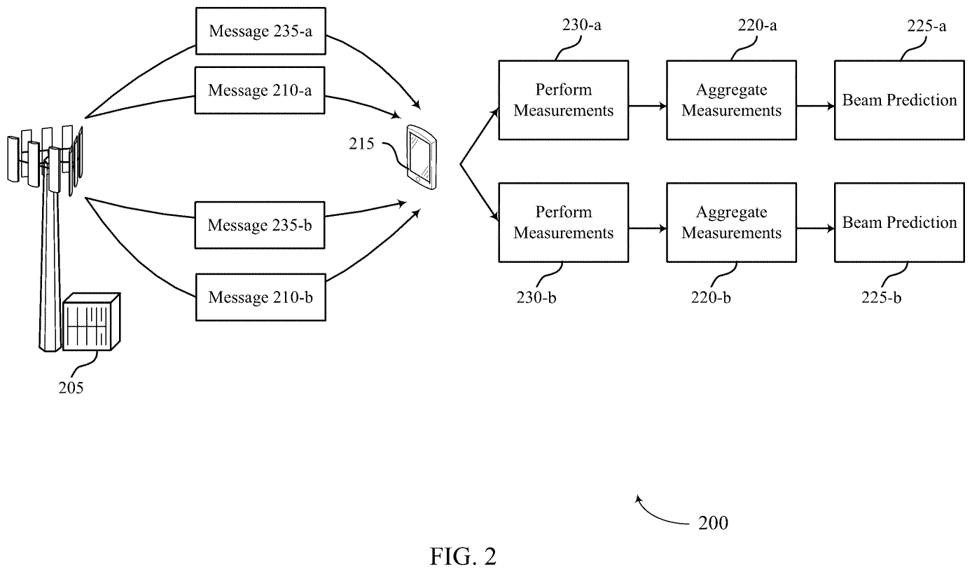

FIG. 2 shows an example of a wireless communications system 200 that supports techniques for signaling parameter identifiers for data collection in beam prediction in accordance with one or more aspects of the present disclosure. The wireless communications system 200 may implement aspects of, or be implemented by aspects of, the wireless communications system 100. For example, the wireless communications system 200 may include a UE 215 and a network entity 205, which may be example of corresponding devices described with reference to FIG. 1.

As described herein, the UE 215 may support scenario-wise beam prediction and data aggregation. The UE 215 may receive reference signals (e.g., SSBs, or CSI-RSs) via one or more beams, and may perform one or more measurement on the reference signals received via one or more configured beams. For example, the UE 215 may measure SSBs or CSI-RSs, and may log a measured level 1 (L1) RSRP, which can be further used to train a ML model (e.g., offline) for one or more procedures, such as time domain (TD) or spatial domain (SD) beam prediction.

Beam prediction may include wide-to-narrow beam prediction. The network may indicate a codebook identifier for two sets of beams (e.g., Set B and Set A), as some abstract information to help the UE 215 to collect data by properly associating the data to the corresponding scenario or configuration and identify applicability of trained ML models to the deployed scenario or configuration during inference. Even though the quantity of beams may be the same in these two codebooks (e.g., hence relying on beam identifiers may not be enough for accurate or successful beam prediction), the learned mapping from Set B to Set A may be different due to different codebooks for Set A and Set B. In some examples, the most abstract information anticipated from the network may be at least the codebook identifiers for Set B and Set A beams.

Even considering intra-cell scenario, the codebook for Set A, Set B may change (e.g., due to gNB turning sub-panels on/off), and notifying the UE 215 of this change may be beneficial in helping the UE 215 collect data accordingly and identify the applicable scenario/configuration during inference.

Although data collection for beam prediction use cases may be autonomously carried out at the UE 215, the network entity 205 may change one or more parameters associated with one or more beams (e.g., beams for transmitting the SSBs or CSI-RSs). For example, the network entity 205 may adaptively adjust an SSB beam to an alternative codebook, or may use different panels for generating SSB beams, or may adjust a transmit power (e.g., a higher transmit power during the day and a lower transmit power at night). Such changes may be based on different statistical information, traffic loads, interference observed by the network entity 205, among other examples. Some such adjustments may be transparent to the UE 215 while collecting data (e.g., L1-RSRPs) for model training. Some such adjustments may not be transparent to the UE 215. If the UE 215 performs measurement aggregation, model training, and beam selection based on a ML model, without accurately identifying such parameter changes, may lead to inefficient or inaccurate model training, poor beam prediction, failed beam prediction, degraded communication performance, degraded beam prediction performance, and decreased user experience.

Changes in scenarios or configurations at the network entity 205 may impact performance of ML models. As an example, considering UE-side ML models trained for a first codebook may not generalize well when deployed using a second codebook. Other examples of assistance information from the network to a UE 215 may include gNB antenna panel identifiers, TX power level identifiers, etc. Signaling of assistance information from the network entity 205 to a UE 215 for data collection can be beneficial in helping the UE 215 to identify the corresponding scenario or configuration associated with the collected data, and to tag and aggregate the collected data accordingly. Such assistance information may help the UE 215 in a scenario discovery during inference, which may be beneficial at the UE side at least in two ways.

First, the assistance information or a function of assistance information can be utilized at the UE 215 as auxiliary inputs to the ML models. For example, the UE 215 may have a single ML model that can be utilized for at least two scenarios or configurations, and the UE 215 may be made aware of the corresponding scenario or configuration through assistance information, which could be input to the ML model.

Second, if the UE 215 is aware of the differentiation of scenario or configuration during the data collection phase and can aggregate the collected data given this knowledge, two different ML models may be developed for two different scenarios or configurations.

With this being said, during inference, if the scenario or configuration changes from first to a second one, the UE 215 may switch to the corresponding ML model that had already been trained for the second scenario or configuration. Such scenarios may result in performance degradation that would have been caused if UE continued to use the first ML model. Techniques described herein may support such benefits.

Techniques described herein support signaling allowing access to information regarding one or more parameters used by the network entity 205 (e.g., based on the perspective of the network entity 205) for transmitting SSBs or CSI-RSs, among other examples. For example, techniques described herein may provide a mechanism based on which the UE 215 may determine whether L1 RSRPs, L1 SINRs, or CIRs, among other examples, detected or aggregated over different TD occasions are associated with a same set of parameters, or a different set of parameters. Such indications of parameters may be based on parameter identifiers, or parameter-set identifiers, associated with UE measurements (e.g., RSRP, SINR, CIR, among other examples). Such specific details on such parameter implementations at the network entity 205 may or may not be transparent to the UE 215. Additionally, or alternatively, as described herein, the UE 215 may aggregate data based on a combination of different parameter-sets (e.g. a first dataset with a first SSB codebook, and various CSI-RS codebooks, and second dataset with various SSSB codebooks but the same CSI-RS codebook).

In some examples, the network entity 205 may indicate parameter identifiers (parameter IDs) for the UE 215 corresponding to the collecting of one or more measurements (e.g., RSRP, SINR, CIR, etc.). The UE 215 may be configured via a first message 235-a (e.g., RRC signaling, a MAC-CE message, a DCI message, or a combination thereof) to measure a set of SSBs or CSI-RSs (e.g., at least to measure RSRP, SINR, CIR). The UE 215 may further receive a second message 210-a (e.g., a gNB indication of a parameter identifier for each parameter within a set of parameters associated with the UE measurements (e.g., of the RSRP, SINR, or CIR, among other examples).

In some examples, the second message 210-a may indicate predefined groups of parameters (e.g., an identifier indicating a set of parameter identifiers). Such predefined groups of parameters may be defined in one or more standards documents, or signaled to the UE 215 via control signaling, or a combination thereof. In some examples, a physical definition of each parameter in the parameter group may be predefined in the one or more standards, and the set of parameters may be indicated by the network entity 205 (e.g., as a sub-group of the predefined parameter group). In some examples, a total number (e.g., a total quantity) of parameter identifiers associated with each indicated parameter from the network entity 205 may be further configured (e.g., indicated via the second message 210-a). In some examples, a physical meaning of each identifier for a certain parameter may also be predefined (e.g., in one or more standards), or may be transparent to the UE 215 (e.g., some identifiers may include only logical meanings, but not physical meanings).

In some examples, various sets of parameter identifiers may be indicated to the UE 215. For example, the UE 215 may receive the first message 235-a (e.g., an indication of an SSB/CSI-RS set 1) and a second message 210-a (e.g., an indication of a parameter set 1 corresponding to the SSB/CSI-RS set 1). Similarly, the UE 215 may receive another message 235-b indicating SSB/CSI-RS set 2, and a message 210-b indicating a parameter set 2 corresponding to the SSB/CSI-RS set 2. The indication of the SSB/CSI-RS set 1 may indicate a first set of beams for transmitting the SSBs or CSI-RSs. The indication of the SB/CSI-RS set 2 may indicate a second set of beams for transmitting the SSBs or CSI-RSs. The second set of beams may be the same as the first set of beams (e.g., but may be generated or transmitted using partially or completely different parameters at the network entity 205), or may be partially different, or may be entirely different from the first set of beams.

At 230-a, the UE 215 may perform measurements via the first set of beams for received SSBs or CSI-RSs. The UE 215 may measure L1-RSRPs, L1-SINRs, CIRs, or the like, with respect to the SSB/CSI-RS set 1. At 220-a, the UE 215 may aggregate the measurements, and may perform model training for a beam prediction ML model (e.g., based at least in part on the parameter set 1). At 225-a, the UE 215 may perform beam prediction (e.g., may predict one or more beams with which to communicate with the network entity 205) using a first ML model (e.g., trained at 220-a) based on the aggregated measurements and the parameter set 1 (e.g., a first beam panel, a first transmit power, a first codebook, a first spatial filter, among other examples).

At 230-b, the UE 215 may perform measurements via the second set of beams for received SSBs or CSI-RSs. The UE 215 may measure L1-RSRPs, L1-SINRs, CIRs, or the like, with respect to the SSB/CSI-RS set 2. At 220-b, the UE 215 may aggregate the measurements, and may perform model training for a beam prediction ML model (e.g., based at least in part on the parameter set 2). At 225-b, the UE 215 may perform beam prediction (e.g., may predict one or more beams with which to communicate with the network entity 205) using a second ML model (e.g., trained at 220-b) based on the aggregated measurements and the parameter set 2 (e.g., a second beam panel, a second transmit power, a second codebook, a second spatial filter, among other examples).

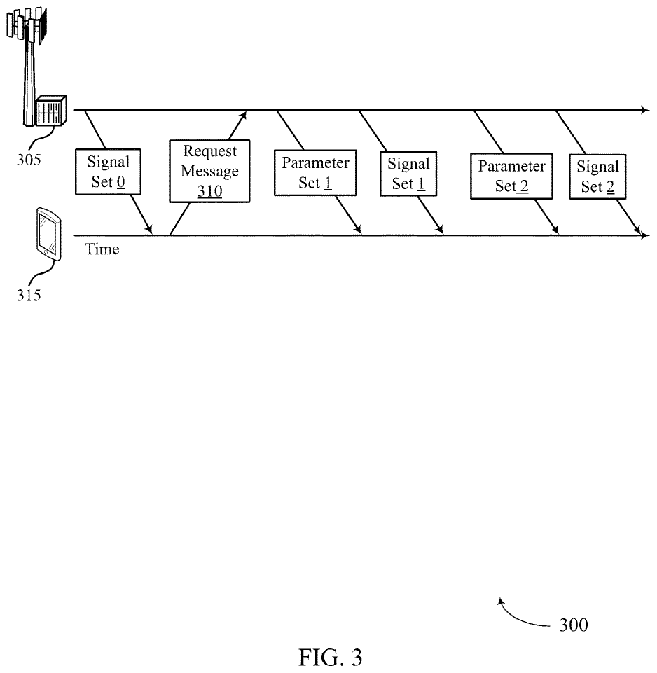

In some examples, as described in greater detail with reference to FIG. 3, the UE 215 may initiate techniques described herein by requesting that the network entity 205 transmit the indication of the parameter identifiers.

FIG. 3 shows an example of a timeline 300 that supports techniques for signaling parameter identifiers for data collection in beam prediction in accordance with one or more aspects of the present disclosure. The timeline 300 may implement aspects of, or be implemented by aspects of, the wireless communications system 100 and the wireless communications system 200. For example, the timeline 300 may include a network entity 305 and a UE 315, which may be examples of corresponding devices described with reference to FIGS. 1-2.

The network entity 305 may provide indications of parameter identifiers to the UE 315, as described with reference to FIG. 2. In some examples, such indications may be conditioned on the UE 315 requesting such SSBs or CSI-RSs for data-collection. The transmission by the network entity 305, which may include the indication of the parameter identifiers, may be dependent on SSBs/CSI-RSs for measurements (e.g., at least one of L1-RSRPs, L1-SINRs, CIRs, or the like), which may be transmitted in response to a UE request for receiving the SSBs/CSI-RSs for data to training the ML model. For example, the network entity may configure the UE 315 with signal set 0 (e.g., a first set of SSBs or CSI-RSs) without providing any indication of the parameters that the network entity 305 is using to transmit SSBs or CSI-RSs as configured in the signal set 0 (e.g., the network entity 305 may not provide an indication of a parameter set). However, if the UE 315 transmits a request message 310 to the network entity 305, then the network entity 305 may transmit an indication of the parameter set 1 corresponding to the signal set 1. For example, the network entity 305 may configure the UE 315 with signal set 1 indicating resources and beams via which to receive the SSBs or CSI-RSs of the signal set 1, and may also configure the UE 315 with the parameter set 1, indicating parameter identifiers for the parameter values that the network entity 305 will use to transmit the SSBs or CSI-RSs.

The UE 315 may transmit the request message 310 via an RRC message, a MAC-CE message, or an uplink control information (UCI) message. The request message 310 may indicate a request for SSBs or CSI-RSs for data collection to an ML beam prediction model. The request message 310 may simply indicate that the UE 315 supports the ML model, or is initiating training of the ML model. In some examples, the request message 310 may request an indication of one or more parameter sets. In some examples, the UE 315 may indicate specific parameter identifiers of multiple available or supported parameter identifiers corresponding to one or more ML models.

The ML model may be used for spatial domain prediction, temporal domain prediction, frequency domain prediction, or any combination thereof for measurements (e.g., at least one of L1-RSRP, L1-SINR, and CIR). In some examples, the ML model may be used for a threshold quantity of resources (e.g., a top K resources) in terms of the measurements. In such examples, the first set of resources (e.g., resources corresponding to signal set 1 and resources corresponding to signal set 2) may be associated with first and second sets of spatial transmit filters at the network entity 305 (e.g., the network entity 305 may transmit SSBs or CSI-RSs via the resources of signal set 1 using a first spatial transmit filter, and may transmit SSBs or CSI-RSs via the resources of signal set 2 using a second spatial transmit filter).

Measurements described herein, and beam prediction based on the ML model may refer to spatial prediction, temporal prediction, frequency prediction, or any combination thereof. Spatial prediction may stand for or indicate predicting quantities (e.g., predicting beams) with respect to a first set of resources based on measurement of a second set of resources (e.g., the UE 315 may perform measurements via a first set of resources according to the signal set 1, and may input the measurements into the ML model to predict beams for a second set of resources corresponding to the first set of resources). In some examples, control signaling (e.g., configuration of the signal set 1 and the signal set 2) may indicate the relationship between the first set of resources and the second set of resources. Temporal prediction may indicate, or stand for, predicting one or more quantities (e.g., beams) with respect to a first set of resources regarding a future time domain occasion based on historical measurements of a second set of resources (e.g., the UE 315 may perform measurements and aggregate historical measurements, and may predict one or more quantities, such as one or more beams, for future resources). Such first and second sets of resources may be configured by the network entity 305 and indicated in the signal set 1 (e.g., indicating first and second sets of resources) or in the signal set 2 (e.g., indicating another first and second set of resources). Frequency prediction may indicate, or stand for, predicting one or more quantities with respect to a first set of resources regarding a first frequency spectrum based on measurements of a second set of resources measured from a second frequency spectrum.

As described herein, the network entity 305 may indicate parameter identifiers, and such indications may depend on the UE request message 310. As described herein, the request message 310 may request SSBs or CSI-RSs for data collection (e.g., for the beam prediction ML model). The network entity 305 may indicate a parameter set 1 (e.g., one or more parameter identifiers indicating parameters the network entity 305 uses for transmission of SSBs or CSI-RSs according to signal set 1). The network entity 305 may also transmit an indication (e.g., via control signaling) of signal set 1. If the network entity 305 changes the parameters it will use to transmit SSBs or CSI-RSs, the network entity may transmit an indication of parameter set 2 to the UE 315. In some examples, the network entity 305 may transmit an indication of signal set 2 (e.g., resources and/or beams for transmitting SSBs or CSI-RSs according to the parameter set 2). The UE 315 may perform measurements via the signal set 1 according to the parameter set 1, and may aggregate and train the ML model based thereon. The UE 315 may also perform measurements via the signal set 2 according to the parameter set 2, and may aggregate and train the ML model based thereon.

The indication of the parameter identifiers may indicate one or more specific identifiers, as described with reference to FIG. 2. In some examples, the network entity 305 may configure the UE 315 with a list of parameter identifiers, and the indication of a parameter set may indicate one or more parameter identifiers of the list of parameter identifiers. In some examples, the indication of the parameter set may indicate and define each parameter identifier (e.g., without reference to previously configured parameter identifiers). The indication of parameter identifiers may indicate physical meanings, logical meanings, or a combination thereof.

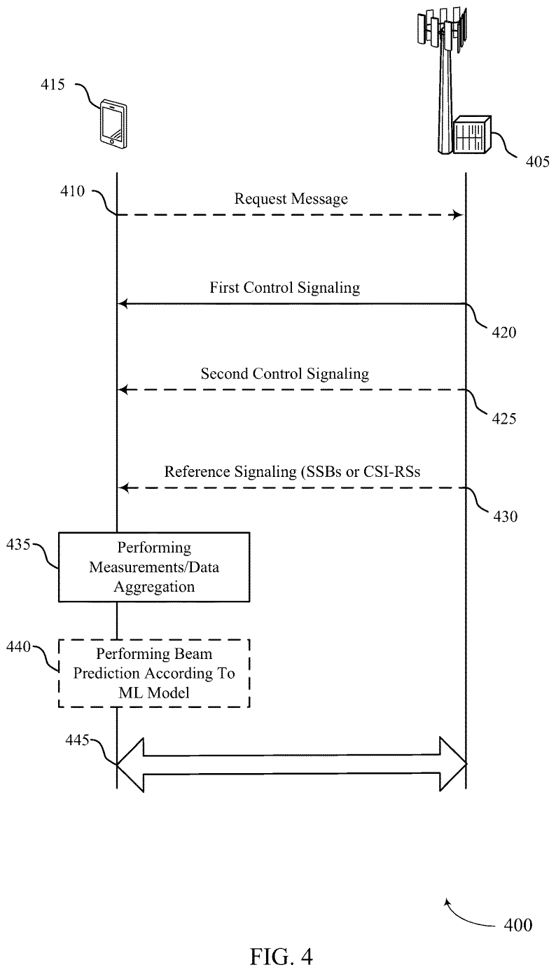

FIG. 4 shows an example of a process flow 400 that supports techniques for signaling parameter identifiers for data collection in beam prediction in accordance with one or more aspects of the present disclosure. The process flow 400 may implement aspects of, or be implemented by aspects of, the wireless communications system 100, the wireless communications system 200, or the timeline 300. For example, the timeline 300 may include a network entity 405 and a UE 415, which may be examples of corresponding devices described with reference to FIGS. 1-3.

At 420, the UE 415 may receive (e.g., from the network entity 405) first control signaling. The first control signaling may indicate beams (e.g., spatial resources, time resources, frequency resources, or a combination thereof) for a set of measurements (e.g., RSRP, SINR, CIR, among other examples).

At 425, the UE 415 may receive (e.g., from the network entity 405) second control signaling. The second control signaling may indicate a first set of parameter identifiers associated with the set of measurements. Each parameter identifier of the first set of parameter identifiers may correspond to the entire set of candidate beams (e.g., the SSB beams or CSI-RS beams indicated in the first control signaling), or each parameter identifier may correspond to an individual candidate beam (e.g., to a respective SSB beam or CSI-RS beam of the set of SSB beams or CSI-RS beams indicated in the first control signaling).

In some examples, the standard may predefine the parameter groups, which may include at least one of the following parameters (e.g., as indicated by the parameter identifiers). For example, the parameter identifiers may include a spatial transmit filter codebook identifier associated with UE measured SSBs or CSI-RSs. Such an identifier may be based on indicating a single codebook identifier for all of the UE measured set of SSBs or CSI-RSs, or may be based on indicating a spatial transmit filter codebook identifier for each SSB or CSI-RS in the UE measured set of SSBs or CSI-RSs.

Characteristics of the spatial transmit filter may also include a quantity of antenna elements, an antenna down-tilting angle, an array form factor, an array shape, a panel identifier, or any combination thereof. In some examples, the parameter identifiers may include an antenna panel identifier associated with the UE measured SSBs or CSI-RSs. Such an identifier may be a single panel identifier for all the UE measured set of SSBs or CSI-RSs, or may indicate respective panel identifiers for each SSB or CSI-RS in the UE measured set of SSBs or CSI-RSs.

In some examples, the parameter identifiers may include an indication of whether a measured SSBs or CSI-RSs are involved with a reconfigurable intelligent surface. If so, the parameter identifiers may include an identifier associated with the RIS. Such an identifier may indicate a single panel identifier for all the UE measured set of SSBs or CSI-RSs, or may indicate respective panel identifiers for each SSB or CSI-RS in the UE measured set of SSBs or CSI-RSs. IN some examples, the identifier may indicate whether (e.g., yes or no) the indicated RIS is involved for all UE measured set of SSBs or CSI-RSs, or indicating a single set of identifiers of RISs for all of the UE measured set of SSBs or CSI-RSs. In some cases, such identifiers may indicate a respective yes or no for involving an RIS for each SSB or CSI-RS in the UE measured set of SSBs or CSI-RSs, or may indicate a respective set of identifiers of RISs for each SSB or CSI-RS in the UE measured set of SSBs or CSI-RSs.

In some examples, the parameter identifiers may include an interference level identifier associated with the UE measured SSBs or CSI-RSs, based on measurements or predictions at the network entity 405. Such identifiers may indicate a single interference level identifier for all of the UE measured set of SSBs or CSI-RSs, or may indicate respective interference level identifiers for each SSB or CSI-RS in the UE measured set of SSBs or CSI-RSs.

In some examples, the parameter identifiers may include an environmental identifier, a scenario identifier, a surrounding identifier, or the like,, which may indicate environmental details, associated with the UE measured SBs or CSI-RSs. For instance, such an identifier may include an indoor or outdoor identifier, an urban or rural identifier, a macro-cell or micro-cell identifier, a cell-edge or cell-center identifier, an open area or city building identifier, an indication of trees or other blockages, a human-sensed or human-not-sensed identifier, a human-sensed-level identifier (e.g., indicating a scenario in which crowded people may negatively impact spatial beam prediction), or any combination thereof.

In some examples, the parameter identifiers may include a transmit power level identifier associated with the UE measured SSBs or CSI-RSs. Such identifiers may indicate a single transmit power identifier for all of the UE measured set of SSBs or CSI-RSs, or may indicate respective transmit power identifiers for each SSB or CSI-RS in the UE measured set of SSBs or CSI-RSs.

In some examples, the second control signaling may indicate the parameter identifiers via what may be referred to as an all-in-one parameter identifier. The UE 415 may receive a single parameter identifier (e.g., out of multiple candidate parameter identifiers). The parameter may be defined as a meta parameter associated with a large (e.g., jumbo) quantity of sub-parameters. The sub-parameters may correspond to the parameters described herein, among other examples (e.g., a transmit power, an indication of a RIS, an antenna panel, a scenario/set of conditions, etc.). Thus, a single parameter identifier (e.g., indicated via the second control signaling) may indicate multiple sub-parameters used by the network entity 405 to transmit the SSBs or the CSI-RSs.

In some examples, the parameter identifiers may be defined as similarity levels associated with a reference parameter. The parameter identifier indicated (e.g., for UE-side data collection or UE-side model interference, or other examples in which the network entity 405 provides parameter identifiers for ML models) may be defined as one of multiple candidate identifiers associated with different similarly levels (e.g., in terms of percentage) with respect to a reference setup of the parameter. For instance, the associations between a certain identifier and the corresponding similarly (e.g., in terms of percentage) maybe defined in the standards, or may configured at the UE 415 by the network entity 405. For example, multiple reference parameters may be defined to indicate an environment or scenario (e.g., an indoor or outdoor identifier, an urban or rural identifier, a macro or micro identifier, or the like). For instance, two sets of identifiers may be defined (e.g., one indicating a similarity of a wireless communication environment to an urban environment, and one indicating a similarly of the wireless communication environment to a rural environment. For similarity with an urban reference parameter, a first parameter identifier (1) may indicate 0% similarity, a second parameter identifier (2) may indicate 20% similarity, a third parameter identifier (3) may indicate 40% similarity, a fourth parameter identifier (4) may indicate 60% similarity, a fifth parameter identifier (5) may indicate 80% similarity, and a sixth parameter identifier (6) may indicate 100% similarity. For similarity with an urban reference parameter, a first parameter identifier (1) may indicate 0% similarity, a second parameter identifier (2) may indicate 20% similarity, a third parameter identifier (3) may indicate 40% similarity, a fourth parameter identifier (4) may indicate 60% similarity, a fifth parameter identifier (5) may indicate 80% similarity, and a sixth parameter identifier (6) may indicate 100% similarity.

The network entity may indicate two parameter identifiers, one associated with a similarly level regarding an urban scenario, and the other associated with a similarly level regarding a rural scenario. Definitions of rural and urban scenarios may be defined in one or more standardized predefinitions (e.g., in terms of antenna down-tilting, antenna-height, antenna-array form factor, transmit power, whether one or more obstacles or trees are present, among other examples). For instance, a first parameter identifier of 3 may indicate a 40% similarity to a reference parameter for a reference urban scenario (e.g., comparing current conditions to a reference set of condition in an urban environment), or a second parameter identifier of 5 may indicate an 80% similarity to a reference parameter indicating a reference rural scenario (e.g., comparing current conditions to a reference set of conditions in a rural environment).

At 430, the UE 415 may receive reference signaling (e.g., may receive SSBs or CSI-RSs) via the resources (e.g., the beams) indicated in the first control signaling.

At 435 the UE 415 may perform the measurements via the beams indicated in the first control signaling, and based at least in part on the parameter identifiers and having received the reference signaling.

The second control signaling and the first control signaling may be received in separate signaling or in the same message. The control signaling may include an RRC message, a DCI message, or a MAC-CE message, or any combination thereof. For example, the parameter identifiers may be RRC configured. RRC signaling may include CSI resource settings, or SSB or CSI-RS resource set configuration associated with the UE measurements. Such RRC signaling may also include the parameter identifiers (e.g., the first control signaling and the second control signaling may be received via the RRC signaling, in a single RRC message or multiple RRC messages). In some examples, an RRC message configuring a CSI report setting associated with the measurements or an RRC message such as a CSI-AssociatedReportConfigInfo message with respect to aperiodic CSI reporting associated with the UE measurements may include the parameter identifiers. In some examples, a dedicated RRC message may include the parameter identifiers (e.g., the first control signaling and the second control signaling may be different control messages, such as different RRC messages).

In some examples, the control signaling carrying the parameter identifiers may include a MAC-CE message. The MAC-CE message activating a CSI-RS resource set (e.g., semi-persistent CSI-RS resource set) may also include the parameter identifiers (e.g., the first control signaling may configure semi-persistent resources, and the MAC-CE carrying the second control signaling may activate the resources). In some examples, the MAC-CE may activate a CSI report associated with the UE measured SSBs or CSI-RSs, and may also indicate the parameter identifiers. In some examples, the MAC-CE may be a dedicated MAC-CE message indicating the parameter identifiers.

IN some examples, the control signaling carrying the parameter identifiers may include a DCI message. The DCI message may trigger aperiodic CSI reporting, associated with the UE measured SSBs or CSI-RSs, or the parameter identifiers may be indicated by other dedicated fields in a DCI message.

The UE 415 may then aggregate the set of measurements based on the first set of parameter identifiers. At 440, the UE 415 may perform beam prediction according to a ML model. At 445, the UE 415 may communicate with the network entity 405 via one or more beams predicted and selected at 440 in accordance with the ML model according to the set of measurements performed at 435. IN some examples, the UE 415 may train the first ML model based on the measurements, and based on the data aggregation.

In some examples, receiving the second control signaling at 425 may be based on transmitting a request message. For example, at 410, the UE 415 may transmit a request message (e.g., such as a request message 310, as described with reference to FIG. 3) indicating that the UE 415 supports data collection for one or more ML models (e.g., including the first ML model) corresponding to beam prediction based on the set of measurements. Receiving the second control signaling at 425 including the indication of the first set of parameter identifiers may be based at least in part on transmitting the request message at 410.

In some examples, the UE 415 may receive third control signaling indicating a second set of parameter identifiers, the second set of parameter identifiers associated with a second ML model corresponding to beam prediction based on the set of measurements (e.g., an indication of parameter set 2 as described with reference to FIG. 3). In such examples, the UE 415 ay perform additional measurements (e.g., a second set of measurements) via a second set of beams (e.g., as indicated by signaling set 2 as described with reference to FIG. 3) based on the second set of parameter identifiers, and may communicate with the network entity 405 via a second one or more beams selected based on the second ML model according to the second set of measurements.

The UE 415 may determine a timing during which the indicated parameter identifiers are applicable. The UE 415 may determine a timing based on explicit signaling (e.g., third control signaling indicating a threshold time period after transmitting an acknowledgement (ACK) message corresponding to the second control signaling at which point the parameter identifiers are to be applied) or implicit determination (e.g., the parameters indicated by the parameter identifiers may be applicable for resources configured by the first control signaling). For example, if the parameter identifiers are carried by control signaling separated from the UE measured SSBs or CSI-RSs (e.g., in a dedicated MAC-CE or a dedicated DCI field), then the UE 415 may determine that the parameters at the network entity 405 are switched to the indicated parameters on a predefined timeline (e.g., indicated in one or more standards, or configured by the network entity 405). For instance, the UE 415 may determine that parameters are switched to the indicated parameters a threshold amount of time (e.g., X ms) after the UE 415 transmits an ACK message with respect to the received second control signaling (e.g., after a MAC-CE or DCI indicating the parameter identifiers).

The value of X may be defined in the standards, or indicated by the network entity 405. In some examples, if the second control signaling is carried based on an indication directly associated with the UE measured SSBs or CSI-RSS (e.g., via a CSI-RS resource configuration or report setting, or via an SSB or CSI resource set configuration, via MAC-CE activating a CSI report or a CSI-RS resource set, an RRC message such as a CSI-AssociatedReportConfiInfo, among other examples), the UE 415 may determine that the indicated parameters apply to the SSBs or CSI-RSs configured via such signaling (e.g., the indicated parameter identifiers are applicable to the SSBs or CSI-RSs that the UE 415 is configured to measure, as indicated in the first control signaling).

In some examples, the UE 415 may receive control signaling (e.g., the first control signaling, the second control signaling, or a separate control message) indicating a beam prediction mode. For example, the UE 415 may receive the indication of the parameter identifiers during an inference procedure. The UE 415 may receive one or more of the parameter identifiers when the UE is requested (e.g., by the network entity 15-c) to carry out beam prediction (e.g., based on ML model inference). The network entity 405 may configure or indicate the first set of SSBs or CSI-RSs as measurement resources (e.g., which may be referred to as set-B beams), and a second set of resources (e.g., based on the SSBS or CSI-RSs, or virtual resources) as prediction targets. The network entity 405 may further indicate one or more of the parameter identifiers (e.g., separately or jointly) associated with the two sets of resources. The UE may further use the indicated parameter identifiers to at least identify an appropriate ML model for the network entity indicated beam prediction mode.

In some examples, the UE 415 may receive the second control signaling indicating the parameter identifiers, and may select a ML model based thereon. For example, the UE 415 may further use the indicated parameter identifiers to at least identify an appropriate ML model for the network requested beam prediction procedures.

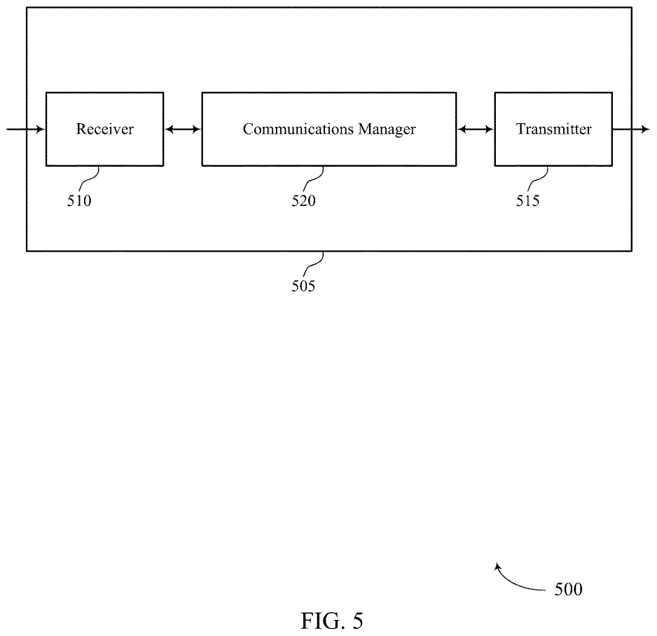

FIG. 5 shows a block diagram 500 of a device 505 that supports techniques for signaling parameter identifiers for data collection in beam prediction in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for signaling parameter identifiers for data collection in beam prediction). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for signaling parameter identifiers for data collection in beam prediction). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of techniques for signaling parameter identifiers for data collection in beam prediction as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 is capable of, configured to, or operable to support a means for receiving first control signaling indicating a set of multiple beams for a set of measurements, the set of measurements including reference signal receive power, a signal to interference and noise ratio, a channel impulsive response, or any combination thereof. The communications manager 520 is capable of, configured to, or operable to support a means for receiving second control signaling including an indication of a first set of parameter identifiers of a set of multiple parameter identifiers, the first set of parameter identifiers associated with the set of measurements. The communications manager 520 is capable of, configured to, or operable to support a means for performing the set of measurements via the set of multiple beams based on the first set of parameter identifiers. The communications manager 520 is capable of, configured to, or operable to support a means for aggregating the set of measurements based on the first set of parameter identifiers.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for beam prediction using a ML model resulting in more efficient beam prediction and selection, improved reliability of wireless signaling, improved throughput, decreased system latency, and improved user experience.

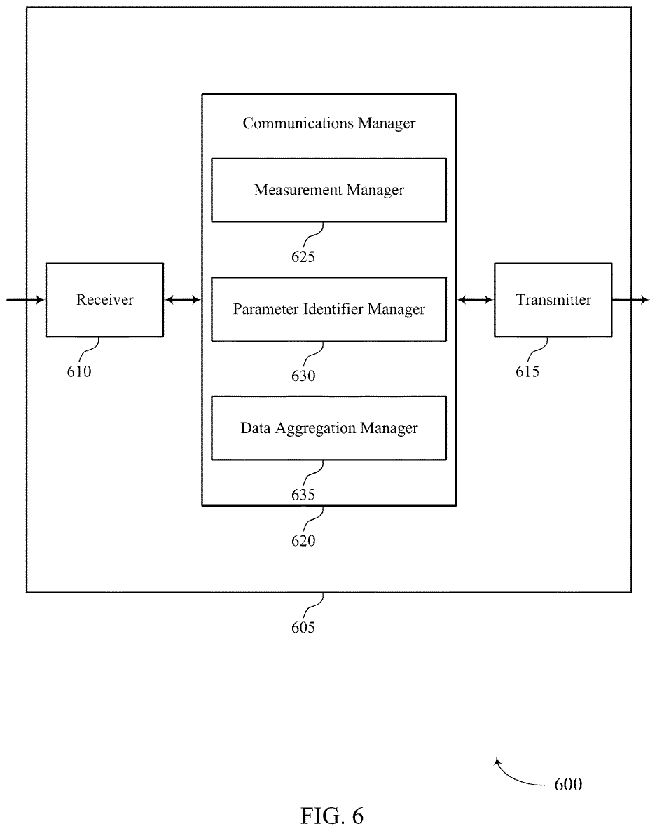

FIG. 6 shows a block diagram 600 of a device 605 that supports techniques for signaling parameter identifiers for data collection in beam prediction in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for signaling parameter identifiers for data collection in beam prediction). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for signaling parameter identifiers for data collection in beam prediction). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for signaling parameter identifiers for data collection in beam prediction as described herein. For example, the communications manager 620 may include a measurement manager 625, a parameter identifier manager 630, a data aggregation manager 635, or any combination thereof.

The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The measurement manager 625 is capable of, configured to, or operable to support a means for receiving first control signaling indicating a set of multiple beams for a set of measurements, the set of measurements including reference signal receive power, a signal to interference and noise ratio, a channel impulsive response, or any combination thereof. The parameter identifier manager 630 is capable of, configured to, or operable to support a means for receiving second control signaling including an indication of a first set of parameter identifiers of a set of multiple parameter identifiers, the first set of parameter identifiers associated with the set of measurements. The measurement manager 625 is capable of, configured to, or operable to support a means for performing the set of measurements via the set of multiple beams based on the first set of parameter identifiers. The data aggregation manager 635 is capable of, configured to, or operable to support a means for aggregating the set of measurements based on the first set of parameter identifiers.

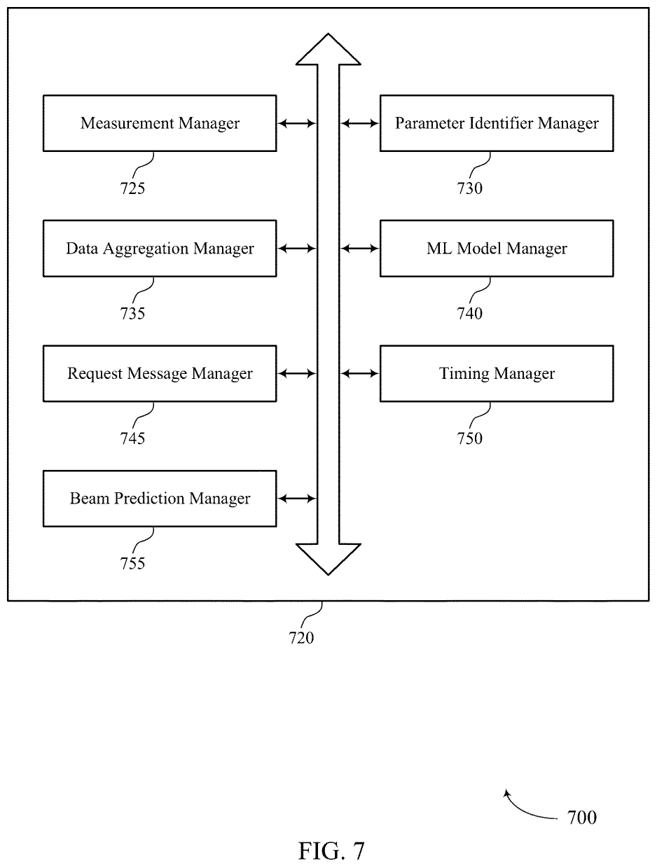

FIG. 7 shows a block diagram 700 of a communications manager 720 that supports techniques for signaling parameter identifiers for data collection in beam prediction in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for signaling parameter identifiers for data collection in beam prediction as described herein. For example, the communications manager 720 may include a measurement manager 725, a parameter identifier manager 730, a data aggregation manager 735, an ML model manager 740, a request message manager 745, a timing manager 750, a beam prediction manager 755, or any combination thereof. Each of these components may communicate, directly or indirectly, with one another (e.g., via one or more buses).

The communications manager 720 may support wireless communications at a UE in accordance with examples as disclosed herein. The measurement manager 725 is capable of, configured to, or operable to support a means for receiving first control signaling indicating a set of multiple beams for a set of measurements, the set of measurements including reference signal receive power, a signal to interference and noise ratio, a channel impulsive response, or any combination thereof. The parameter identifier manager 730 is capable of, configured to, or operable to support a means for receiving second control signaling including an indication of a first set of parameter identifiers of a set of multiple parameter identifiers, the first set of parameter identifiers associated with the set of measurements. In some examples, the measurement manager 725 is capable of, configured to, or operable to support a means for performing the set of measurements via the set of multiple beams based on the first set of parameter identifiers. The data aggregation manager 735 is capable of, configured to, or operable to support a means for aggregating the set of measurements based on the first set of parameter identifiers.

In some examples, the ML model manager 740 is capable of, configured to, or operable to support a means for communicating with a network entity via one or more beams of the set of multiple beams selected in accordance with a first ML model according to the set of measurements.

In some examples, the request message manager 745 is capable of, configured to, or operable to support a means for transmitting a request message indicating that the UE supports data collection for one or more ML models including a first ML model corresponding to beam prediction based on the set of measurements, where receiving the second control signaling including the indication of the first set of parameter identifiers is based on transmitting the request message.

In some examples, the parameter identifier manager 730 is capable of, configured to, or operable to support a means for receiving third control signaling including an indication of a second set of parameter identifiers of the set of multiple parameter identifiers, the second set of parameter identifiers associated with a second ML model corresponding to beam prediction based on the set of measurements.

In some examples, the measurement manager 725 is capable of, configured to, or operable to support a means for performing a second set of measurements via a second set of multiple beams based on the second set of parameter identifiers. In some examples, the ML model manager 740 is capable of, configured to, or operable to support a means for communicating with a network entity via one or more beams of the second set of multiple beams selected in accordance with the second ML model according to the second the set of measurements.

In some examples, the first set of parameter identifiers include a spatial transmission filter codebook identifier associated with the set of multiple beams, an antenna panel identifier associated with one or more beams, an identifier associated with a reconfigurable intelligent surface, a predicted interference level identifier, a transmit power level identifier, a scenario identifier, or any combination thereof.

In some examples, each parameter identifier of the first set of parameter identifiers corresponds to the set of multiple beams.

In some examples, each parameter identifier of the first set of parameter identifiers applies to a respective beam of the set of multiple beams.

In some examples, the parameter identifier manager 730 is capable of, configured to, or operable to support a means for receiving an RRC message including the first control signaling and the second control signaling, the RRC message indicating resources corresponding to the set of multiple beams.

In some examples, the parameter identifier manager 730 is capable of, configured to, or operable to support a means for receiving a MAC control element (CE) activating one or more resources for the set of measurements, the MAC-CE including the second control signaling.

In some examples, the parameter identifier manager 730 is capable of, configured to, or operable to support a means for receiving the second control signaling via a DCI message.

In some examples, the timing manager 750 is capable of, configured to, or operable to support a means for receiving third control signaling including an indication of a threshold time period. In some examples, the timing manager 750 is capable of, configured to, or operable to support a means for transmitting an acknowledgement message corresponding to the second control signaling. In some examples, the timing manager 750 is capable of, configured to, or operable to support a means for applying the first set of parameter identifiers to a first ML model corresponding to beam prediction based on the set of measurements upon expiration of the threshold time period after transmitting the acknowledgement message.

In some examples, the measurement manager 725 is capable of, configured to, or operable to support a means for receiving, via the first control signaling, an indication of a set of resources corresponding to the set of measurements. In some examples, the parameter identifier manager 730 is capable of, configured to, or operable to support a means for applying the first set of parameter identifiers to a first ML model corresponding to beam prediction for the set of measurements via the set of resources based on the first control signaling.

In some examples, the ML model manager 740 is capable of, configured to, or operable to support a means for training a first ML model corresponding to beam prediction based on the set of measurements based on aggregating the measurements, where communicating with a network entity via one or more beams selected in accordance with the first ML model is based on the training.

In some examples, the set of multiple beams correspond to a set of multiple synchronization signal blocks, a set of multiple channel state information reference signals, or a combination thereof.

In some examples, the beam prediction manager 755 is capable of, configured to, or operable to support a means for receiving control signaling indicating a beam prediction mode, where receiving the second control signaling is based on receiving the control signaling indicating the beam prediction mode.

In some examples, the ML model manager 740 is capable of, configured to, or operable to support a means for selecting a first ML model corresponding to beam prediction based on the set of measurements based on the first set of parameter identifiers. In some examples, the beam prediction manager 755 is capable of, configured to, or operable to support a means for performing beam prediction according to the set of measurements and the selected first ML model.

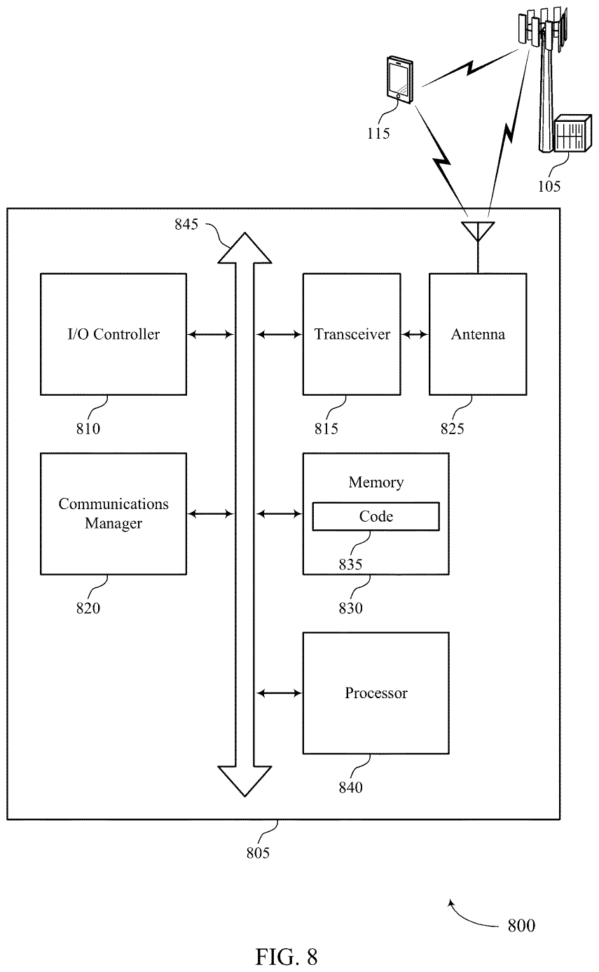

FIG. 8 shows a diagram of a system 800 including a device 805 that supports techniques for signaling parameter identifiers for data collection in beam prediction in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof.

The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for signaling parameter identifiers for data collection in beam prediction). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 is capable of, configured to, or operable to support a means for receiving first control signaling indicating a set of multiple beams for a set of measurements, the set of measurements including reference signal receive power, a signal to interference and noise ratio, a channel impulsive response, or any combination thereof. The communications manager 820 is capable of, configured to, or operable to support a means for receiving second control signaling including an indication of a first set of parameter identifiers of a set of multiple parameter identifiers, the first set of parameter identifiers associated with the set of measurements. The communications manager 820 is capable of, configured to, or operable to support a means for performing the set of measurements via the set of multiple beams based on the first set of parameter identifiers. The communications manager 820 is capable of, configured to, or operable to support a means for aggregating the set of measurements based on the first set of parameter identifiers.

By including or configuring the communications manager 820 in accordance with examples as described herein, the device 805 may support techniques for beam prediction according to an ML model resulting in more efficient beam prediction and selection, improved reliability of wireless signaling, improved signal quality, improved throughput, decreased system latency, and improved user experience.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for signaling parameter identifiers for data collection in beam prediction as described herein, or the processor 840 and the memory 830 may be otherwise configured to perform or support such operations.

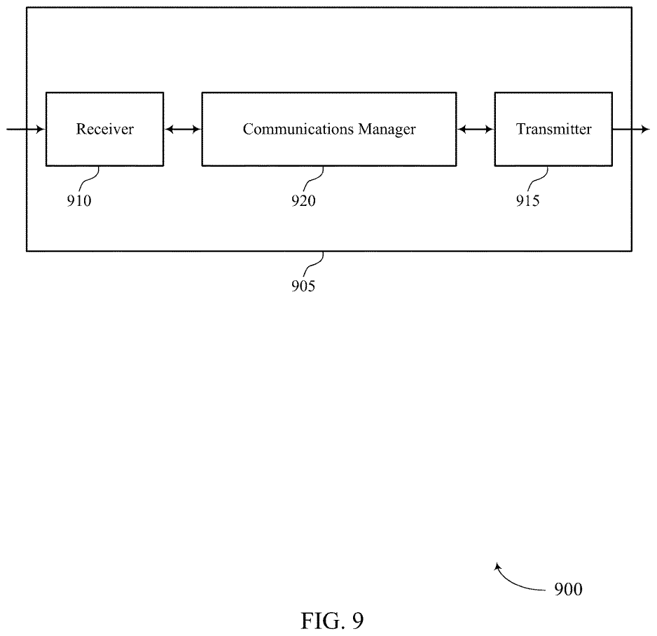

FIG. 9 shows a block diagram 900 of a device 905 that supports techniques for signaling parameter identifiers for data collection in beam prediction in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas.

Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of techniques for signaling parameter identifiers for data collection in beam prediction as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 is capable of, configured to, or operable to support a means for transmitting first control signaling indicating a set of multiple beams for a set of measurements by a UE, the set of measurements including reference signal receive power, a signal to interference and noise ratio, a channel impulsive response, or any combination thereof. The communications manager 920 is capable of, configured to, or operable to support a means for transmitting second control signaling including an indication of a first set of parameter identifiers of a set of multiple parameter identifiers, the first set of parameter identifiers associated with the set of measurements. The communications manager 920 is capable of, configured to, or operable to support a means for communicating with the UE via one or more beams of the set of multiple beams based on the first set of parameter identifiers, and the set of measurements.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for beam prediction using a ML model resulting in more efficient beam prediction and selection, improved reliability of wireless signaling, improved throughput, decreased system latency, and improved user experience.

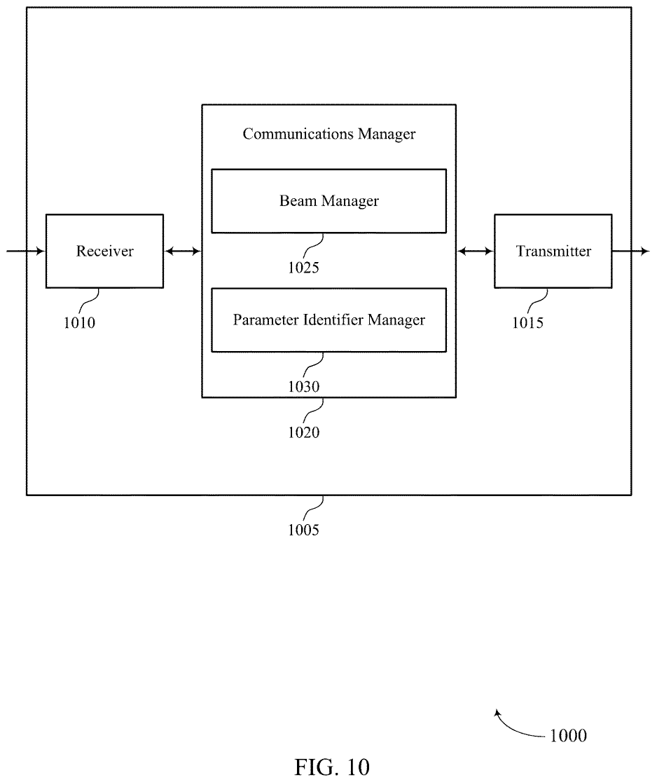

FIG. 10 shows a block diagram 1000 of a device 1005 that supports techniques for signaling parameter identifiers for data collection in beam prediction in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas.

Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for signaling parameter identifiers for data collection in beam prediction as described herein. For example, the communications manager 1020 may include a beam manager 1025 a parameter identifier manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The beam manager 1025 is capable of, configured to, or operable to support a means for transmitting first control signaling indicating a set of multiple beams for a set of measurements by a UE, the set of measurements including reference signal receive power, a signal to interference and noise ratio, a channel impulsive response, or any combination thereof. The parameter identifier manager 1030 is capable of, configured to, or operable to support a means for transmitting second control signaling including an indication of a first set of parameter identifiers of a set of multiple parameter identifiers, the first set of parameter identifiers associated with the set of measurements. The beam manager 1025 is capable of, configured to, or operable to support a means for communicating with the UE via one or more beams of the set of multiple beams based on the first set of parameter identifiers, and the set of measurements.

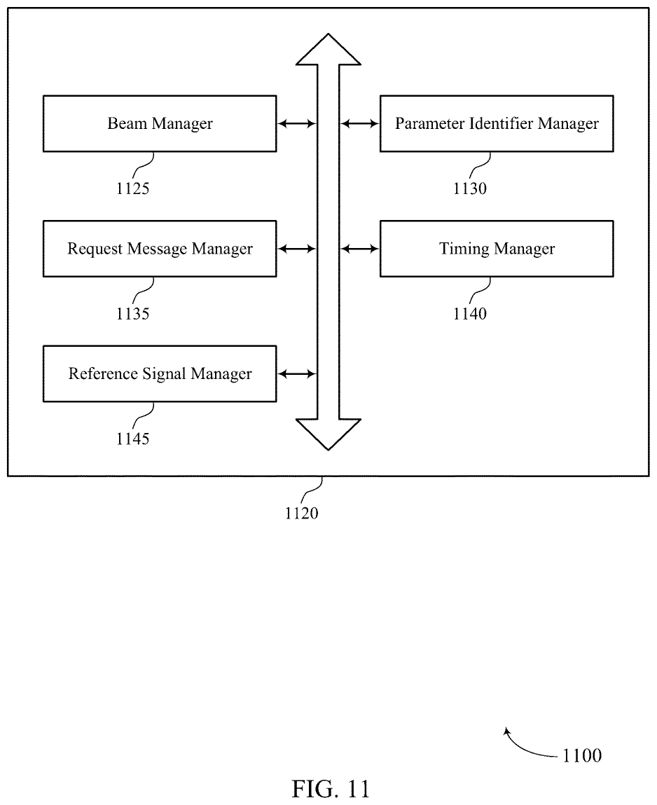

FIG. 11 shows a block diagram 1100 of a communications manager 1120 that supports techniques for signaling parameter identifiers for data collection in beam prediction in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for signaling parameter identifiers for data collection in beam prediction as described herein. For example, the communications manager 1120 may include a beam manager 1125, a parameter identifier manager 1130, a request message manager 1135, a timing manager 1140, a reference signal manager 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The beam manager 1125 is capable of, configured to, or operable to support a means for transmitting first control signaling indicating a set of multiple beams for a set of measurements by a UE, the set of measurements including reference signal receive power, a signal to interference and noise ratio, a channel impulsive response, or any combination thereof. The parameter identifier manager 1130 is capable of, configured to, or operable to support a means for transmitting second control signaling including an indication of a first set of parameter identifiers of a set of multiple parameter identifiers, the first set of parameter identifiers associated with the set of measurements. In some examples, the beam manager 1125 is capable of, configured to, or operable to support a means for communicating with the UE via one or more beams of the set of multiple beams based on the first set of parameter identifiers, and the set of measurements.

In some examples, the request message manager 1135 is capable of, configured to, or operable to support a means for receiving a request message indicating that the UE supports data collection for one or more ML models including a first ML model corresponding to beam prediction based on the set of measurements, where transmitting the second control signaling including the indication of the first set of parameter identifiers is based on receiving the request message.

In some examples, the parameter identifier manager 1130 is capable of, configured to, or operable to support a means for transmitting third control signaling including an indication of a second set of parameter identifiers of the set of multiple parameter identifiers, the second set of parameter identifiers associated with a second ML model corresponding to beam prediction based on the set of measurements. In some examples, the beam manager 1125 is capable of, configured to, or operable to support a means for performing additional communications with the UE via one or more beams of a second set of multiple beams in accordance with the second ML model, the second set of parameter identifiers, and the set of measurements.

In some examples, the reference signal manager 1145 is capable of, configured to, or operable to support a means for transmitting, via the set of multiple beams, a first set of reference signals based on the first set of parameter identifiers using a first transmission filter, where the communicating with the UE is based on the first set of reference signals. In some examples, the reference signal manager 1145 is capable of, configured to, or operable to support a means for transmitting, via a second set of multiple beams, a second set of reference signals based on the second set of parameter identifiers using a second transmission filter, where performing the additional communications with the UE is based on the second set of reference signals.

In some examples, the first transmission filter at least partially overlaps with the second transmission filter.

In some examples, the first set of parameter identifiers include a spatial transmission filter codebook identifier associated with the set of multiple beams, an antenna panel identifier associated with one or more beams, an identifier associated with a reconfigurable intelligent surface, a predicted interference level identifier, a transmit power level identifier, a scenario identifier, or any combination thereof.

In some examples, each parameter identifier of the first set of parameter identifiers corresponds to the set of multiple beams.

In some examples, each parameter identifier of the first set of parameter identifiers applies to a respective beam of the set of multiple beams.

In some examples, the second control signaling includes a MAC control element (CE), an RRC message, a DCI message, or any combination thereof.

In some examples, the timing manager 1140 is capable of, configured to, or operable to support a means for transmitting third control signaling including an indication of a threshold time period, where the communicating with the UE occurs at least the threshold time period after receiving an acknowledgement message corresponding to the second control signaling.

In some examples, the set of multiple beams correspond to a set of multiple synchronization signal blocks, a set of multiple channel state information reference signals, or a combination thereof.

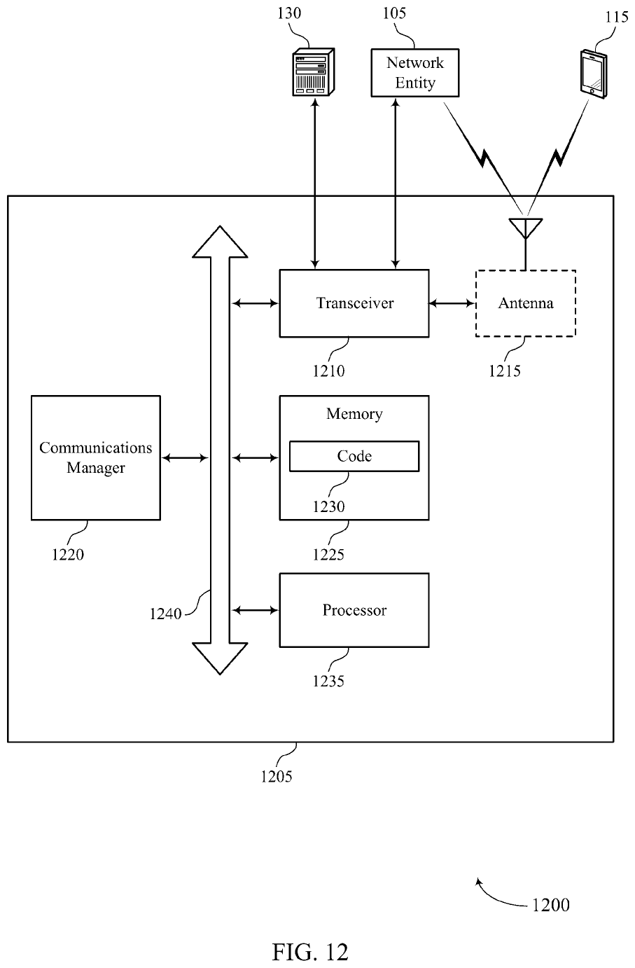

FIG. 12 shows a diagram of a system 1200 including a device 1205 that supports techniques for signaling parameter identifiers for data collection in beam prediction in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting techniques for signaling parameter identifiers for data collection in beam prediction). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 is capable of, configured to, or operable to support a means for transmitting first control signaling indicating a set of multiple beams for a set of measurements by a UE, the set of measurements including reference signal receive power, a signal to interference and noise ratio, a channel impulsive response, or any combination thereof. The communications manager 1220 is capable of, configured to, or operable to support a means for transmitting second control signaling including an indication of a first set of parameter identifiers of a set of multiple parameter identifiers, the first set of parameter identifiers associated with the set of measurements. The communications manager 1220 is capable of, configured to, or operable to support a means for communicating with the UE via one or more beams of the set of multiple beams based on the first set of parameter identifiers, and the set of measurements.

By including or configuring the communications manager 1220 in accordance with examples as described herein, the device 1205 may support techniques for beam prediction according to an ML model resulting in more efficient beam prediction and selection, improved reliability of wireless signaling, improved signal quality, improved throughput, decreased system latency, and improved user experience.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of techniques for signaling parameter identifiers for data collection in beam prediction as described herein, or the processor 1235 and the memory 1225 may be otherwise configured to perform or support such operations.

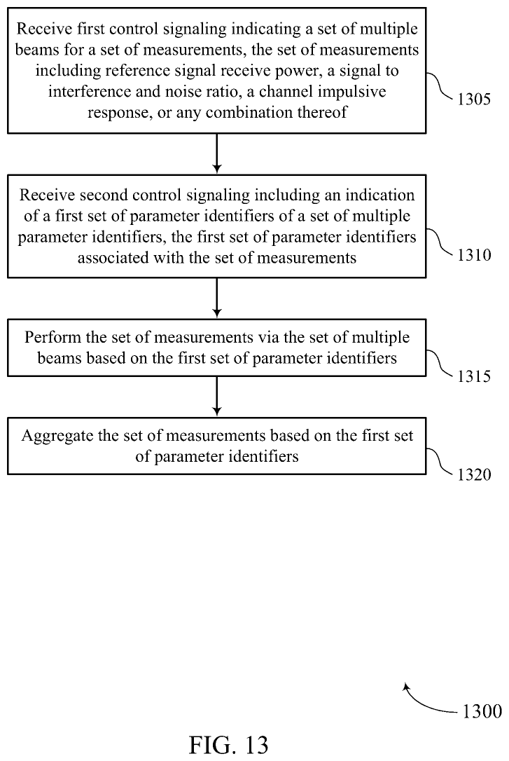

FIG. 13 shows a flowchart illustrating a method 1300 that supports techniques for signaling parameter identifiers for data collection in beam prediction in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving first control signaling indicating a set of multiple beams for a set of measurements, the set of measurements including reference signal receive power, a signal to interference and noise ratio, a channel impulsive response, or any combination thereof. The operations of block 1305 may be performed in accordance with examples as disclosed herein. In some examples, aspects of the operations of 1305 may be performed by a measurement manager 725 as described with reference to FIG. 7.

At 1310, the method may include receiving second control signaling including an indication of a first set of parameter identifiers of a set of multiple parameter identifiers, the first set of parameter identifiers associated with the set of measurements. The operations of block 1310 may be performed in accordance with examples as disclosed herein. In some examples, aspects of the operations of 1310 may be performed by a parameter identifier manager 730 as described with reference to FIG. 7.

At 1315, the method may include performing the set of measurements via the set of multiple beams based on the first set of parameter identifiers. The operations of block 1315 may be performed in accordance with examples as disclosed herein. In some examples, aspects of the operations of 1315 may be performed by a measurement manager 725 as described with reference to FIG. 7.

At 1320, the method may include aggregating the set of measurements based on the first set of parameter identifiers. The operations of block 1320 may be performed in accordance with examples as disclosed herein. In some examples, aspects of the operations of 1320 may be performed by a data aggregation manager 735 as described with reference to FIG. 7.

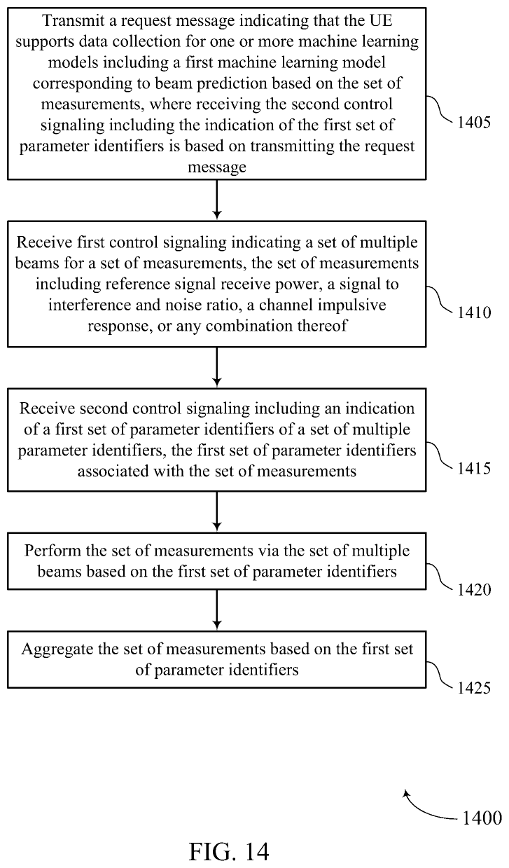

FIG. 14 shows a flowchart illustrating a method 1400 that supports techniques for signaling parameter identifiers for data collection in beam prediction in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include transmitting a request message indicating that the UE supports data collection for one or more ML models including a first ML model corresponding to beam prediction based on the set of measurements, where receiving the second control signaling including the indication of the first set of parameter identifiers is based on transmitting the request message. The operations of block 1405 may be performed in accordance with examples as disclosed herein. In some examples, aspects of the operations of 1405 may be performed by a request message manager 745 as described with reference to FIG. 7.

At 1410, the method may include receiving first control signaling indicating a set of multiple beams for a set of measurements, the set of measurements including reference signal receive power, a signal to interference and noise ratio, a channel impulsive response, or any combination thereof. The operations of block 1410 may be performed in accordance with examples as disclosed herein. In some examples, aspects of the operations of 1410 may be performed by a measurement manager 725 as described with reference to FIG. 7.

At 1415, the method may include receiving second control signaling including an indication of a first set of parameter identifiers of a set of multiple parameter identifiers, the first set of parameter identifiers associated with the set of measurements. The operations of block 1415 may be performed in accordance with examples as disclosed herein. In some examples, aspects of the operations of 1415 may be performed by a parameter identifier manager 730 as described with reference to FIG. 7.

At 1420, the method may include performing the set of measurements via the set of multiple beams based on the first set of parameter identifiers. The operations of block 1420 may be performed in accordance with examples as disclosed herein. In some examples, aspects of the operations of 1420 may be performed by a measurement manager 725 as described with reference to FIG. 7.

At 1425, the method may include aggregating the set of measurements based on the first set of parameter identifiers. The operations of block 1425 may be performed in accordance with examples as disclosed herein. In some examples, aspects of the operations of 1425 may be performed by a data aggregation manager 735 as described with reference to FIG. 7.

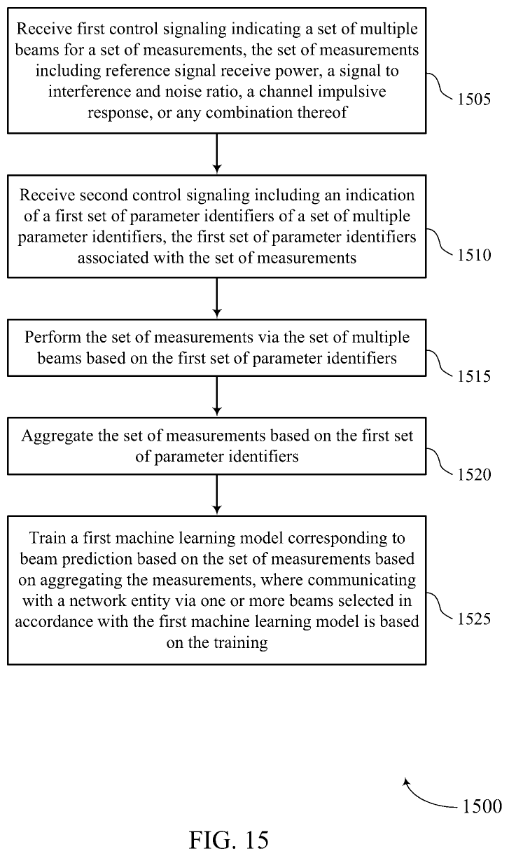

FIG. 15 shows a flowchart illustrating a method 1500 that supports techniques for signaling parameter identifiers for data collection in beam prediction in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving first control signaling indicating a set of multiple beams for a set of measurements, the set of measurements including reference signal receive power, a signal to interference and noise ratio, a channel impulsive response, or any combination thereof. The operations of block 1505 may be performed in accordance with examples as disclosed herein. In some examples, aspects of the operations of 1505 may be performed by a measurement manager 725 as described with reference to FIG. 7.

At 1510, the method may include receiving second control signaling including an indication of a first set of parameter identifiers of a set of multiple parameter identifiers, the first set of parameter identifiers associated with the set of measurements. The operations of block 1510 may be performed in accordance with examples as disclosed herein. In some examples, aspects of the operations of 1510 may be performed by a parameter identifier manager 730 as described with reference to FIG. 7.

At 1515, the method may include performing the set of measurements via the set of multiple beams based on the first set of parameter identifiers. The operations of block 1515 may be performed in accordance with examples as disclosed herein. In some examples, aspects of the operations of 1515 may be performed by a measurement manager 725 as described with reference to FIG. 7.

At 1520, the method may include aggregating the set of measurements based on the first set of parameter identifiers. The operations of block 1520 may be performed in accordance with examples as disclosed herein. In some examples, aspects of the operations of 1520 may be performed by a data aggregation manager 735 as described with reference to FIG. 7.

At 1525, the method may include training a first ML model corresponding to beam prediction based on the set of measurements based on aggregating the measurements, where communicating with a network entity via one or more beams selected in accordance with the first ML model is based on the training. The operations of block 1525 may be performed in accordance with examples as disclosed herein. In some examples, aspects of the operations of 1525 may be performed by an ML model manager 740 as described with reference to FIG. 7.

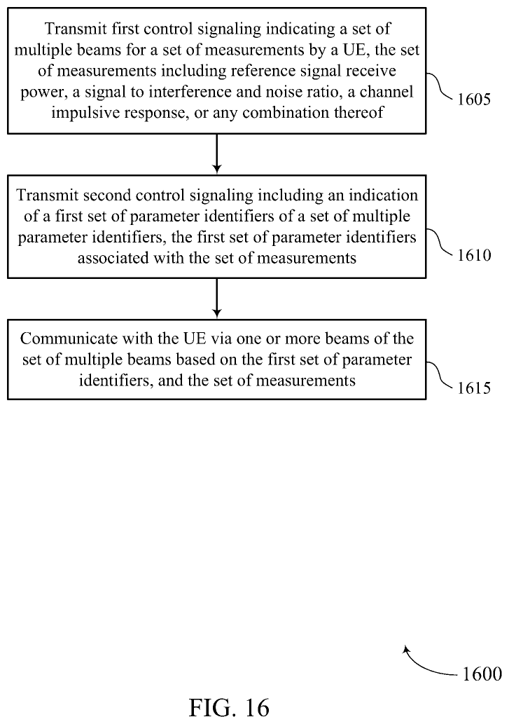

FIG. 16 shows a flowchart illustrating a method 1600 that supports techniques for signaling parameter identifiers for data collection in beam prediction in accordance with aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting first control signaling indicating a set of multiple beams for a set of measurements by a UE, the set of measurements including reference signal receive power, a signal to interference and noise ratio, a channel impulsive response, or any combination thereof. The operations of block 1605 may be performed in accordance with examples as disclosed herein. In some examples, aspects of the operations of 1605 may be performed by a beam manager 1125 as described with reference to FIG. 11.

At 1610, the method may include transmitting second control signaling including an indication of a first set of parameter identifiers of a set of multiple parameter identifiers, the first set of parameter identifiers associated with the set of measurements. The operations of block 1610 may be performed in accordance with examples as disclosed herein. In some examples, aspects of the operations of 1610 may be performed by a parameter identifier manager 1130 as described with reference to FIG. 11.

At 1615, the method may include communicating with the UE via one or more beams of the set of multiple beams based on the first set of parameter identifiers, and the set of measurements. The operations of block 1615 may be performed in accordance with examples as disclosed herein. In some examples, aspects of the operations of 1615 may be performed by a beam manager 1125 as described with reference to FIG. 11.

The following provides an overview of aspects of the present disclosure:
Aspect 1: A method for wireless communications at a UE, comprising: receiving first control signaling indicating a plurality of beams for a set of measurements, the set of measurements including reference signal receive power, a signal to interference and noise ratio, a channel impulsive response, or any combination thereof; receiving second control signaling comprising an indication of a first set of parameter identifiers of a plurality of parameter identifiers, the first set of parameter identifiers associated with the set of measurements; performing the set of measurements via the plurality of beams based at least in part on the first set of parameter identifiers; and aggregating the set of measurements based at least in part on the first set of parameter identifiers.
Aspect 2: The method of aspect 1, further comprising: communicating with a network entity via one or more beams of the plurality of beams selected in accordance with a first ML model according to the set of measurements.
Aspect 3: The method of any of aspects 1 through 2, further comprising: transmitting a request message indicating that the UE supports data collection for one or more ML models comprising a first ML model corresponding to beam prediction based on the set of measurements, wherein receiving the second control signaling comprising the indication of the first set of parameter identifiers is based at least in part on transmitting the request message.
Aspect 4: The method of any of aspects 1 through 3, further comprising: receiving third control signaling comprising an indication of a second set of parameter identifiers of the plurality of parameter identifiers, the second set of parameter identifiers associated with a second ML model corresponding to beam prediction based on the set of measurements.
Aspect 5: The method of aspect 4, further comprising: performing a second set of measurements via a second plurality of beams based at least in part on the second set of parameter identifiers; and communicating with a network entity via one or more beams of the second plurality of beams selected in accordance with the second ML model according to the second the set of measurements.
Aspect 6: The method of any of aspects 1 through 5, wherein the first set of parameter identifiers comprise a spatial transmission filter codebook identifier associated with the plurality of beams, an antenna panel identifier associated with one or more beams, an identifier associated with a reconfigurable intelligent surface, a predicted interference level identifier, a transmit power level identifier, a scenario identifier, or any combination thereof.
Aspect 7: The method of aspect 6, wherein each parameter identifier of the first set of parameter identifiers corresponds to the plurality of beams.
Aspect 8: The method of any of aspects 6 through 7, wherein each parameter identifier of the first set of parameter identifiers applies to a respective beam of the plurality of beams.
Aspect 9: The method of any of aspects 1 through 8, further comprising: receiving an RRC message comprising the first control signaling and the second control signaling, the RRC message indicating resources corresponding to the plurality of beams.
Aspect 10: The method of any of aspects 1 through 9, further comprising: receiving a MAC-CE activating one or more resources for the set of measurements, the MAC-CE comprising the second control signaling.
Aspect 11: The method of any of aspects 1 through 10, further comprising: receiving the second control signaling via a DCI message.
Aspect 12: The method of any of aspects 1 through 11, further comprising: receiving third control signaling comprising an indication of a threshold time period; transmitting an acknowledgement message corresponding to the second control signaling; and applying the first set of parameter identifiers to a first ML model corresponding to beam prediction based on the set of measurements upon expiration of the threshold time period after transmitting the acknowledgement message.
Aspect 13: The method of any of aspects 1 through 12, further comprising: receiving, via the first control signaling, an indication of a set of resources corresponding to the set of measurements; and applying the first set of parameter identifiers to a first ML model corresponding to beam prediction for the set of measurements via the set of resources based at least in part on the first control signaling.
Aspect 14: The method of any of aspects 1 through 13, further comprising: training a first ML model corresponding to beam prediction based on the set of measurements based at least in part on aggregating the measurements, wherein communicating with a network entity via one or more beams selected in accordance with the first ML model is based at least in part on the training.
Aspect 15: The method of any of aspects 1 through 14, wherein the plurality of beams correspond to a plurality of synchronization signal blocks, a plurality of channel state information reference signals, or a combination thereof.
Aspect 16: The method of any of aspects 1 through 15, further comprising: receiving control signaling indicating a beam prediction mode, wherein receiving the second control signaling is based at least in part on receiving the control signaling indicating the beam prediction mode.
Aspect 17: The method of any of aspects 1 through 16, further comprising: selecting a first ML model corresponding to beam prediction based on the set of measurements based at least in part on the first set of parameter identifiers; and performing beam prediction according to the set of measurements and the selected first ML model.
Aspect 18: The method of any of aspects 1 through 17, wherein the indication of the first set of parameter identifiers of the plurality of parameter identifiers comprises a set of similarly values, each similarity value indicating a percentage of similarly between a parameter identifier of the first set of parameter identifiers and a respective reference parameter value.
Aspect 19: A method for wireless communications at a network entity, comprising: transmitting first control signaling indicating a plurality of beams for a set of measurements by a UE, the set of measurements comprising reference signal receive power, a signal to interference and noise ratio, a channel impulsive response, or any combination thereof; transmitting second control signaling comprising an indication of a first set of parameter identifiers of a plurality of parameter identifiers, the first set of parameter identifiers associated with the set of measurements; and communicating with the UE via one or more beams of the plurality of beams based at least in part on the first set of parameter identifiers, and the set of measurements.
Aspect 20: The method of aspect 19, further comprising: receiving a request message indicating that the UE supports data collection for one or more ML models comprising a first ML model corresponding to beam prediction based on the set of measurements, wherein transmitting the second control signaling comprising the indication of the first set of parameter identifiers is based at least in part on receiving the request message.
Aspect 21: The method of any of aspects 19 through 20, further comprising: transmitting third control signaling comprising an indication of a second set of parameter identifiers of the plurality of parameter identifiers, the second set of parameter identifiers associated with a second ML model corresponding to beam prediction based on the set of measurements; and performing additional communications with the UE via one or more beams of a second plurality of beams in accordance with the second ML model, the second set of parameter identifiers, and the set of measurements.
Aspect 22: The method of aspect 21, further comprising: transmitting, via the plurality of beams, a first set of reference signals based at least in part on the first set of parameter identifiers using a first transmission filter, wherein the communicating with the UE is based at least in part on the first set of reference signals; and transmitting, via a second plurality of beams, a second set of reference signals based at least in part on the second set of parameter identifiers using a second transmission filter, wherein performing the additional communications with the UE is based at least in part on the second set of reference signals.
Aspect 23: The method of aspect 22, wherein the first transmission filter at least partially overlaps with the second transmission filter.
Aspect 24: The method of any of aspects 19 through 23, wherein the first set of parameter identifiers comprise a spatial transmission filter codebook identifier associated with the plurality of beams, an antenna panel identifier associated with one or more beams, an identifier associated with a reconfigurable intelligent surface, a predicted interference level identifier, a transmit power level identifier, a scenario identifier, or any combination thereof.
Aspect 25: The method of aspect 24, wherein each parameter identifier of the first set of parameter identifiers corresponds to the plurality of beams.
Aspect 26: The method of any of aspects 24 through 25, wherein each parameter identifier of the first set of parameter identifiers applies to a respective beam of the plurality of beams.
Aspect 27: The method of any of aspects 19 through 26, further comprising: transmitting third control signaling comprising an indication of a threshold time period, wherein the communicating with the UE occurs at least the threshold time period after receiving an acknowledgement message corresponding to the second control signaling.
Aspect 28: The method of any of aspects 19 through 27, wherein the plurality of beams correspond to a plurality of synchronization signal blocks, a plurality of channel state information reference signals, or a combination thereof.
Aspect 29: An apparatus for wireless communications at a UE, comprising a processor; memory coupled with the processor; and instructions stored in the memory and executable by the processor to cause the apparatus to perform a method of any of aspects 1 through 18.
Aspect 30: An apparatus for wireless communications at a UE, comprising at least one means for performing a method of any of aspects 1 through 18.
Aspect 31: A non-transitory computer-readable medium storing code for wireless communications at a UE, the code comprising instructions executable by a processor to perform a method of any of aspects 1 through 18.
Aspect 32: An apparatus for wireless communications at a network entity, comprising a processor; memory coupled with the processor; and instructions stored in the memory and executable by the processor to cause the apparatus to perform a method of any of aspects 19 through 28.
Aspect 33: An apparatus for wireless communications at a network entity, comprising at least one means for performing a method of any of aspects 19 through 28.
Aspect 34: A non-transitory computer-readable medium storing code for wireless communications at a network entity, the code comprising instructions executable by a processor to perform a method of any of aspects 19 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method for wireless communications at a user equipment (UE), comprising:
receiving first control signaling indicating a plurality of beams for a set of measurements, the set of measurements including reference signal receive power, a signal to interference and noise ratio, a channel impulsive response, or any combination thereof;
receiving second control signaling comprising an indication of a first set of parameter identifiers of a plurality of parameter identifiers, the first set of parameter identifiers associated with the set of measurements;
performing the set of measurements via the plurality of beams based at least in part on the first set of parameter identifiers; and
aggregating the set of measurements based at least in part on the first set of parameter identifiers.

2. The method of claim 1, further comprising:
communicating with a network entity via one or more beams of the plurality of beams selected in accordance with a first machine learning model according to the set of measurements.

3. The method of claim 1, further comprising:
transmitting a request message indicating that the UE supports data collection for one or more machine learning models comprising a first machine learning model corresponding to beam prediction based on the set of measurements, wherein receiving the second control signaling comprising the indication of the first set of parameter identifiers is based at least in part on transmitting the request message.

4. The method of claim 1, further comprising:
receiving third control signaling comprising an indication of a second set of parameter identifiers of the plurality of parameter identifiers, the second set of parameter identifiers associated with a second machine learning model corresponding to beam prediction based on the set of measurements.

5. The method of claim 4, further comprising:
performing a second set of measurements via a second plurality of beams based at least in part on the second set of parameter identifiers; and
communicating with a network entity via one or more beams of the second plurality of beams selected in accordance with the second machine learning model according to the second the set of measurements.

6. The method of claim 1, wherein the first set of parameter identifiers comprise a spatial transmission filter codebook identifier associated with the plurality of beams, an antenna panel identifier associated with one or more beams, an identifier associated with a reconfigurable intelligent surface, a predicted interference level identifier, a transmit power level identifier, a scenario identifier, or any combination thereof.

7. The method of claim 6, wherein each parameter identifier of the first set of parameter identifiers corresponds to the plurality of beams.

8. The method of claim 6, wherein each parameter identifier of the first set of parameter identifiers applies to a respective beam of the plurality of beams.

9. The method of claim 1, further comprising:
receiving a radio resource control message comprising the first control signaling and the second control signaling, the radio resource control message indicating resources corresponding to the plurality of beams.

10. The method of claim 1, further comprising:
receiving a media access control (MAC) control element (CE) activating one or more resources for the set of measurements, the MAC-CE comprising the second control signaling.

11. The method of claim 1, further comprising:
receiving the second control signaling via a downlink control information message.

12. The method of claim 1, further comprising:
receiving third control signaling comprising an indication of a threshold time period;
transmitting an acknowledgement message corresponding to the second control signaling; and
applying the first set of parameter identifiers to a first machine learning model corresponding to beam prediction based on the set of measurements upon expiration of the threshold time period after transmitting the acknowledgement message.

13. The method of claim 1, further comprising:
receiving, via the first control signaling, an indication of a set of resources corresponding to the set of measurements; and
applying the first set of parameter identifiers to a first machine learning model corresponding to beam prediction for the set of measurements via the set of resources based at least in part on the first control signaling.

14. The method of claim 1, further comprising:
training a first machine learning model corresponding to beam prediction based on the set of measurements based at least in part on aggregating the measurements, wherein communicating with a network entity via one or more beams selected in accordance with the first machine learning model is based at least in part on the training.

15. The method of claim 1, wherein the plurality of beams correspond to a plurality of synchronization signal blocks, a plurality of channel state information reference signals, or a combination thereof.

16. The method of claim 1, further comprising:
receiving control signaling indicating a beam prediction mode, wherein receiving the second control signaling is based at least in part on receiving the control signaling indicating the beam prediction mode.

17. The method of claim 1, further comprising:
selecting a first machine learning model corresponding to beam prediction based on the set of measurements based at least in part on the first set of parameter identifiers; and
performing beam prediction according to the set of measurements and the selected first machine learning model.

18. The method of claim 1, wherein the indication of the first set of parameter identifiers of the plurality of parameter identifiers comprises a set of similarly values, each similarity value indicating a percentage of similarly between a parameter identifier of the first set of parameter identifiers and a respective reference parameter value.

19. A method for wireless communications at a network entity, comprising:
transmitting first control signaling indicating a plurality of beams for a set of measurements by a user equipment (UE), the set of measurements comprising reference signal receive power, a signal to interference and noise ratio, a channel impulsive response, or any combination thereof;
transmitting second control signaling comprising an indication of a first set of parameter identifiers of a plurality of parameter identifiers, the first set of parameter identifiers associated with the set of measurements; and
communicating with the UE via one or more beams of the plurality of beams based at least in part on the first set of parameter identifiers, and the set of measurements.

20-28. (canceled)

29. An apparatus for wireless communications at a user equipment (UE), comprising:
a processor;
memory coupled with the processor; and
instructions stored in the memory and executable by the processor to cause the apparatus to:
receive first control signaling indicating a plurality of beams for a set of measurements, the set of measurements including reference signal receive power, a signal to interference and noise ratio, a channel impulsive response, or any combination thereof;
receive second control signaling comprising an indication of a first set of parameter identifiers of a plurality of parameter identifiers, the first set of parameter identifiers associated with the set of measurements;
perform the set of measurements via the plurality of beams based at least in part on the first set of parameter identifiers; and
aggregate the set of measurements based at least in part on the first set of parameter identifiers.

30. (canceled)
